(19) United States
(12) Patent Application Publication
(10) Pub. No.: US 2017/0048833 A1
(43) Pub. Date: Feb. 16, 2017

(54) METHOD FOR TRANSMITTING DOWNLINK DATA, MOBILITY MANAGEMENT NETWORK ELEMENT, ACCESS NETWORK DEVICE, AND SERVING GATEWAY

(71) Applicant: Huawei Technologies Co., Ltd., Shenzhen (CN)

(72) Inventors: Wei LU, Shanghai (CN); Fenqin ZHU, Shanghai (CN)

(21) Appl. No.: 15/337,761

(22) Filed: Oct. 28, 2016

Related U.S. Application Data
(63) Continuation of application No. PCT/CN2014/076586, filed on Apr. 30, 2014.

(51) Int. Cl. H04W 72/04; H04W 68/02; H04W 72/08; H04W 88/16

(52) U.S. Cl. CPC H04W 72/042; H04W 88/16; H04W 68/02; H04W 72/08; H04W 72/0486

(57) ABSTRACT

Disclosed is a method for transmitting downlink data, a mobility management network element, an access network device, and a serving gateway. The method includes: receiving a downlink data notification message sent by a serving gateway, where the downlink data notification message includes a category attribute of to-be-transmitted downlink data; acquiring the category attribute, of the to-be-transmitted downlink data, included in the downlink data notification message; and determining, according to the category attribute of the to-be-transmitted downlink data, whether to send a paging message to an access network device. For the method for transmitting downlink data, in a process of transmitting downlink data, establishment of a bearer on an access network side can be controlled, so as to prevent blind establishment of a bearer on the access network side. As such, signaling overheads can be reduced and congestion in data transmission can be mitigated.

### CROSS-REFERENCE TO RELATED APPLICATIONS

This application is a continuation of International Application No. PCT/CN2014/076586, filed on Apr. 30, 2014, the disclosure of which is hereby incorporated by reference in its entirety.

### TECHNICAL FIELD

The present disclosure relates to the communications field, and in particular, to a method for transmitting downlink data, a mobility management network element, an access network device, and a serving gateway in the communications field.

### BACKGROUND

In the 3rd Generation Partnership Project (“3GPP”), a user equipment (“UE”) transmits data by using a bearer established with a network-side device. A path for transmitting downlink data is as follows: Downlink data is transmitted from the Internet to a packet data network gateway (“PGW”). The PGW transmits the downlink data to a serving gateway (“SGW”). The SGW sends, by using a bearer related to an access network device, the downlink data to the access network device, where the access network device is, for example, an evolved NodeB (“eNB”). Therefore, the access network device transmits the downlink data to the UE.

When the UE neither has a data transmission service nor has a voice service within a period of time, to save both air interface resources and electrical power of the UE, the UE may be switched to an idle state. Correspondingly, the bearer related to the access network device is also temporarily deleted. For example, in this case, a bearer between the SGW and the eNB is deleted, and a bearer between the eNB and the UE is also deleted.

For the UE switched to the idle state, when downlink data needs to be sent to the UE, the downlink data is transmitted to the SGW by using a bearer on a core network side, and the SGW sends a downlink data notification message to a mobility management entity (“MME”). After receiving the downlink data notification message, the MME may page the UE by using the access network device in a tracking area in which the UE is located. After receiving a paging message, the UE initiates a service request procedure, so as to restore the bearer related to the access network device, for example, restore the bearer between the eNB and the SGW and the bearer between the UE and the eNB. Therefore, the SGW may send the downlink data to the eNB by using the bearer between the eNB and the SGW, and the eNB may further send the downlink data to the UE by using the bearer between the UE and the eNB, thereby implementing data transmission.

As mobile phone applications become more popular, various applications that occupy high bandwidth, for example, videos and online games, also grow larger in number. These applications greatly occupy network bandwidth resources, and may cause congestion in data transmission of an access network device.

At present, a method for solving congestion in data transmission of an access network device is: performing, by an access network device, differentiated processing according to a category attribute of a data packet. Specifically, first, a network-side device, for example, a device such as a policy and charging rules function (“PCRF”) entity and a policy and charging enforcement function (“PCEF”) entity may categorize data packets according to a subscriber type, a service type, and a subscription data condition, and may identify data packets of a same category by using a same identifier, where the identifier may be placed in a specific field in a header of the data packets to identify a feature of the data packets. Next, the data packets are sent to an access network device in an access network via devices such as a PGW and an SGW. The access network device may perform differentiated processing according to features of the data packets, for example, preferentially process a data packet having a high priority, discard a data packet having a low priority, and the like.

The disadvantage of the foregoing method is that an access network device can execute a differentiated operation according to a different category attribute of downlink data only after receiving the downlink data. When UE is in an idle state, the downlink data can be sent to the access network device only after a bearer between the access network device and an SGW and a bearer between the UE and the access network device are restored. If the downlink data is downlink data having a low priority, after the bearer between the access network device and the SGW and the bearer between the UE and the access network device have been established, the downlink data may still be discarded by the access network device when reaching an access network. Therefore, such a signaling process of establishing a bearer is useless and therefore may cause redundancy in signaling overheads.

### SUMMARY

Embodiments of the present disclosure provide a method for transmitting downlink data, a mobility management network element, an access network device, and a serving gateway, which can reduce signaling overheads.

According to a first aspect, a method for transmitting downlink data is provided, where the method includes: receiving a downlink data notification message sent by a serving gateway; acquiring a category attribute, of to-be-transmitted downlink data, included in the downlink data notification message; and determining, according to the category attribute of the to-be-transmitted downlink data, whether to send a paging message to an access network device, where the paging message is used for instructing the access network device to establish a bearer used for transmitting the to-be-transmitted downlink data.

With reference to the first aspect, in a first possible implementation manner of the first aspect, the method further includes: receiving a congestion notification message sent by the access network device, where the congestion notification message includes a downlink data control policy, where the downlink data control policy is used for indicating a category attribute set of downlink data whose transmission is allowed or transmission is forbidden; and the determining, according to the category attribute of the to-be-transmitted downlink data, whether to send a paging message to an access network device includes: determining, according to the category attribute of the to-be-transmitted downlink data and the downlink data control policy, whether to send the paging message to the access network device.

With reference to the first aspect, in a second possible implementation manner of the first aspect, the method further includes: receiving a congestion notification message sent by the access network device, where the congestion notification message includes congestion information used for indicating a current congested state of an access network; and the determining, according to the category attribute of the to-be-transmitted downlink data, whether to send a paging message to an access network device includes: determining a downlink data control policy according to the congestion information, where the downlink data control policy is used for indicating a category attribute set of downlink data whose transmission is allowed or transmission is forbidden; and determining, according to the category attribute of the to-be-transmitted downlink data and the downlink data control policy, whether to send the paging message to the access network device.

With reference to the first or second possible implementation manner of the first aspect, in a third possible implementation manner of the first aspect, the determining, according to the category attribute of the to-be-transmitted downlink data and the downlink data control policy, whether to send the paging message to the access network device includes: when it is determined that the category attribute of the to-be-transmitted downlink data belongs to the category attribute set, of the downlink data whose transmission is allowed, indicated by the downlink data control policy, or when it is determined that the category attribute of the to-be-transmitted downlink data does not belong to the category attribute set, of the downlink data whose transmission is forbidden, indicated by the downlink data control policy, determining to send the paging message to the access network device.

With reference to any possible implementation manner of the first to third possible implementation manners of the first aspect, in a fourth possible implementation manner of the first aspect, after the determining to send the paging message to the access network device, the method further includes: sending a downlink data acknowledgement message to the serving gateway, where the downlink data acknowledgement message includes the downlink data control policy.

With reference to any possible implementation manner of the first to fourth possible implementation manners of the first aspect, in a fifth possible implementation manner of the first aspect, the congestion notification message further includes congested cell information used for indicating a congested cell; and after the determining to send the paging message to the access network device, the method further includes: sending the paging message to the access network device, where the paging message includes the congested cell information in the congestion notification message, so as to instruct the access network device not to page user equipment in the congested cell.

With reference to the first aspect or any possible implementation manner of the first to fifth possible implementation manners of the first aspect, in a sixth possible implementation manner of the first aspect, the determining, according to the category attribute of the to-be-transmitted downlink data, whether to send a paging message to an access network device includes: when it is determined to send the paging message to the access network device, for at least two pieces of the to-be-transmitted downlink data, determining, according to at least one piece of information of the category attribute, a subscription attribute of the user equipment, and a quality of service class identifier QCI attribute, an order of sending the paging message to the access network device.

With reference to the first aspect or any possible implementation manner of the first to sixth possible implementation manners of the first aspect, in a seventh possible implementation manner of the first aspect, the category attribute of the to-be-transmitted downlink data includes at least one piece of information of the following information: service type information of the to-be-transmitted downlink data, priority information of the to-be-transmitted downlink data, and quality of service information of the to-be-transmitted downlink data.

According to a second aspect, a method for transmitting downlink data is provided, where the method includes: receiving a first paging message sent by a mobility management network element; acquiring a category attribute, of to-be-transmitted downlink data, included in the first paging message; determining current load information of an access network; and determining, according to the load information and the category attribute, whether to send a second paging message to target user equipment of the to-be-transmitted downlink data, where the second paging message is used for instructing the target user equipment to establish a bearer used for transmitting the to-be-transmitted downlink data.

With reference to the second aspect, in a first possible implementation manner of the second aspect, the determining, according to the load information and the category attribute, whether to send a second paging message to target user equipment of the to-be-transmitted downlink data includes: determining a downlink data control policy according to the load information, where the downlink data control policy is used for indicating a category attribute set of downlink data whose transmission is allowed or transmission is forbidden; and when it is determined that the category attribute of the to-be-transmitted downlink data belongs to the category attribute set, of the downlink data whose transmission is allowed, indicated by the downlink data control policy, or when it is determined that the category attribute of the to-be-transmitted downlink data does not belong to the category attribute set, of the downlink data whose transmission is forbidden, indicated by the downlink data control policy, determining to send the second paging message to the target user equipment.

With reference to the second aspect or the first possible implementation manner of the second aspect, in a second possible implementation manner of the second aspect, the category attribute of the to-be-transmitted downlink data includes at least one piece of information of the following information: service type information of the to-be-transmitted downlink data, priority information of the to-be-transmitted downlink data, and quality of service information of the to-be-transmitted downlink data.

According to a third aspect, a method for transmitting downlink data is provided, where the method includes: receiving a downlink data acknowledgement message sent by a mobility management network element, where the downlink data acknowledgement message is used for instructing a serving gateway to transmit first to-be-transmitted downlink data, and the downlink data acknowledgement message includes a downlink data control policy, where the downlink data control policy is used for indicating a category attribute set of downlink data whose transmission is allowed or transmission is forbidden; acquiring the downlink data control policy included in the downlink data acknowledgement message; receiving second to-be-transmitted downlink data sent by a packet data network gateway; and determining, according to a category attribute of the second to-be-transmitted downlink data and the downlink data control policy, whether to send a downlink data notification message to the mobility management network element, where the downlink data notification message is used for indicating that the second to-be-transmitted downlink data to be transmitted to user equipment exists.

With reference to the third aspect, in a first possible implementation manner of the third aspect, the determining, according to a category attribute of the second to-be-transmitted downlink data and the downlink data control policy, whether to send a downlink data notification message to the mobility management network element includes: when it is determined that the category attribute of the second to-be-transmitted downlink data belongs to the category attribute set, of the downlink data whose transmission is allowed, indicated by the downlink data control policy, or when it is determined that the category attribute of the second to-be-transmitted downlink data does not belong to the category attribute set, of the downlink data whose transmission is forbidden, indicated by the downlink data control policy, determining to send the downlink data notification message to the mobility management network element.

With reference to the third aspect or the first possible implementation manner of the third aspect, in a second possible implementation manner of the third aspect, the category attribute of the second to-be-transmitted downlink data includes at least one piece of information of the following information: service type information of the second to-be-transmitted downlink data, priority information of the second to-be-transmitted downlink data, and quality of service information of the second to-be-transmitted downlink data.

According to a fourth aspect, a mobility management network element is provided, where the mobility management network element includes: a receiving module, configured to receive a downlink data notification message sent by a serving gateway; an acquiring module, configured to acquire a category attribute, of to-be-transmitted downlink data, included in the downlink data notification message received by the receiving module; and a determining module, configured to determine, according to the category attribute, of the to-be-transmitted downlink data, acquired by the acquiring module, whether to send a paging message to an access network device, where the paging message is used for instructing the access network device to establish a bearer used for transmitting the to-be-transmitted downlink data.

With reference to the fourth aspect, in a first possible implementation manner of the fourth aspect, the receiving module is further configured to receive a congestion notification message sent by the access network device, where the congestion notification message includes a downlink data control policy, where the downlink data control policy is used for indicating a category attribute set of downlink data whose transmission is allowed or transmission is forbidden; and the determining module includes: a first determining unit, configured to determine, according to the category attribute of the to-be-transmitted downlink data and the downlink data control policy received by the receiving module, whether to send the paging message to the access network device.

With reference to the fourth aspect, in a second possible implementation manner of the fourth aspect, the receiving module is further configured to receive a congestion notification message sent by the access network device, where the congestion notification message includes congestion information used for indicating a current congested state of an access network; and the determining module includes: a second determining unit, configured to determine a downlink data control policy according to the congestion information received by the receiving module, where the downlink data control policy is used for indicating a category attribute set of downlink data whose transmission is allowed or transmission is forbidden; and a third determining unit, configured to determine, according to the category attribute of the to-be-transmitted downlink data and the downlink data control policy determined by the second determining unit, whether to send the paging message to the access network device.

With reference to the first or second possible implementation manner of the fourth aspect, in a third possible implementation manner of the fourth aspect, the determining module is specifically configured to: when it is determined that the category attribute of the to-be-transmitted downlink data belongs to the category attribute set, of the downlink data whose transmission is allowed, indicated by the downlink data control policy, or when it is determined that the category attribute of the to-be-transmitted downlink data does not belong to the category attribute set, of the downlink data whose transmission is forbidden, indicated by the downlink data control policy, determine to send the paging message to the access network device.

With reference to any possible implementation manner of the first to third possible implementation manners of the fourth aspect, in a fourth possible implementation manner of the fourth aspect, the mobility management network element further includes: a sending module, configured to: after the determining module determines to send the paging message to the access network device, send a downlink data acknowledgement message to the serving gateway, where the downlink data acknowledgement message includes the downlink data control policy.

With reference to any possible implementation manner of the first to third possible implementation manners of the fourth aspect, in a fifth possible implementation manner of the fourth aspect, the congestion notification message further includes congested cell information used for indicating a congested cell; and the mobility management network element further includes: a sending module, configured to: after the determining module determines to send the paging message to the access network device, send the paging message to the access network device, where the paging message includes the congested cell information in the congestion notification message, so as to instruct the access network device not to page user equipment in the congested cell.

With reference to the fourth aspect or any possible implementation manner of the first to fifth possible implementation manners of the fourth aspect, in a sixth possible implementation manner of the fourth aspect, the determining module includes: a fourth determining unit, configured to: when it is determined to send the paging message to the access network device, for at least two pieces of the to-be-transmitted downlink data, determine, according to at least one piece of information of the category attribute, a subscription attribute of the user equipment, and a quality of service class identifier QCI attribute, an order of sending the paging message to the access network device.

With reference to the fourth aspect or any possible implementation manner of the first to sixth possible implementation manners of the fourth aspect, in a seventh possible implementation manner of the fourth aspect, the category attribute, of the to-be-transmitted downlink data, acquired by the acquiring module includes at least one piece of information of the following information: service type information of the to-be-transmitted downlink data, priority information of the to-be-transmitted downlink data, and quality of service information of the to-be-transmitted downlink data.

According to a fifth aspect, an access network device is provided, where the access network device includes: a receiving module, configured to receive a first paging message sent by a mobility management network element; an acquiring module, configured to acquire a category attribute, of to-be-transmitted downlink data, included in the first paging message received by the receiving module; a first determining module, configured to determine current load information of an access network; and a second determining module, configured to determine, according to the load information determined by the first determining module and the category attribute acquired by the acquiring module, whether to send a second paging message to target user equipment of the to-be-transmitted downlink data, where the second paging message is used for instructing the target user equipment to establish a bearer used for transmitting the to-be-transmitted downlink data.

With reference to the fifth aspect, in a first possible implementation manner of the fifth aspect, the second determining module includes: a first determining unit, configured to determine a downlink data control policy according to the load information, where the downlink data control policy is used for indicating a category attribute set of downlink data whose transmission is allowed or transmission is forbidden; and a second determining unit, configured to: when the category attribute of the to-be-transmitted downlink data belongs to the category attribute set, of the downlink data whose transmission is allowed, indicated by the downlink data control policy, or when the category attribute of the to-be-transmitted downlink data does not belong to the category attribute set, of the downlink data whose transmission is forbidden, indicated by the downlink data control policy, determine to send the second paging message to the target user equipment.

With reference to the fifth aspect or the first possible implementation manner of the fifth aspect, in a second possible implementation manner of the fifth aspect, the category attribute, of the to-be-transmitted downlink data, acquired by the acquiring module includes at least one piece of information of the following information: service type information of the to-be-transmitted downlink data, priority information of the to-be-transmitted downlink data, and quality of service information of the to-be-transmitted downlink data.

According to a sixth aspect, a serving gateway is provided, where the serving gateway includes: a receiving module, configured to receive a downlink data acknowledgement message sent by a mobility management network element, where the downlink data acknowledgement message is used for instructing the serving gateway to transmit first to-be-transmitted downlink data, and the downlink data acknowledgement message includes a downlink data control policy, where the downlink data control policy is used for indicating a category attribute set of downlink data whose transmission is allowed or transmission is forbidden; an acquiring module, configured to acquire the downlink data control policy included in the downlink data acknowledgement message received by the receiving module. The receiving module, further configured to receive second to-be-transmitted downlink data sent by a packet data network gateway; and a determining module, configured to determine, according to a category attribute of the second to-be-transmitted downlink data received by the receiving module and the downlink data control policy acquired by the acquiring module, whether to send a downlink data notification message to the mobility management network element, where the downlink data notification message is used for indicating that the second to-be-transmitted downlink data to be transmitted to user equipment exists.

With reference to the sixth aspect, in a first possible implementation manner of the sixth aspect, the determining module is specifically configured to: when the category attribute of the second to-be-transmitted downlink data belongs to the category attribute set, of the downlink data whose transmission is allowed, indicated by the downlink data control policy, or when the category attribute of the second to-be-transmitted downlink data does not belong to the category attribute set, of the downlink data whose transmission is forbidden, indicated by the downlink data control policy, determine to send the downlink data notification message to the mobility management network element.

With reference to the sixth aspect or the first possible implementation manner of the sixth aspect, in a second possible implementation manner of the sixth aspect, the category attribute of the second to-be-transmitted downlink data received by the receiving module includes at least one piece of information of the following information: service type information of the second to-be-transmitted downlink data, priority information of the second to-be-transmitted downlink data, and quality of service information of the second to-be-transmitted downlink data.

On the basis of the foregoing technical solutions, according to the method for transmitting downlink data, the mobility management network element, the access network device, and the serving gateway in the embodiments of the present disclosure, a category attribute of to-be-transmitted downlink data is acquired, and it is determined, according to the category attribute of the to-be-transmitted downlink data, whether to send a paging message to an access network device, so as to determine whether to establish a bearer between the access network device and a serving gateway and a bearer between the access network device and user equipment. Therefore, in a process of transmitting downlink data, establishment of a bearer on an access network side can be controlled, so as to prevent blind establishment of a bearer on the access network side, so that signaling overheads can be reduced, and congestion in data transmission can be mitigated.

### BRIEF DESCRIPTION OF DRAWINGS

To describe the technical solutions in the embodiments of the present disclosure more clearly, the following briefly introduces the accompanying drawings required for describing the embodiments of the present disclosure. Apparently, the accompanying drawings in the following description show merely some embodiments of the present disclosure, and a person of ordinary skill in the art may still derive other drawings from these accompanying drawings without creative efforts.

FIG. 1 is a schematic architecture diagram of an application scenario according to an embodiment of the present disclosure;

FIG. 2 is a schematic flowchart of a method for transmitting downlink data according to an embodiment of the present disclosure;

FIG. 3 is another schematic flowchart of the method for transmitting downlink data according to the embodiment of the present disclosure;

FIG. 4 is a still another schematic flowchart of the method for transmitting downlink data according to the embodiment of the present disclosure;

FIG. 5 is a still another schematic flowchart of the method for transmitting downlink data according to the embodiment of the present disclosure;

FIG. 6 is a schematic flowchart of a method for transmitting downlink data according to another embodiment of the present disclosure;

FIG. 7 is another schematic flowchart of the method for transmitting downlink data according to the another embodiment of the present disclosure;

FIG. 8 is a schematic flowchart of a method for transmitting downlink data according to still another embodiment of the present disclosure;

FIG. 9 is a schematic flowchart of a method for transmitting downlink data according to still another embodiment of the present disclosure;

FIG. 10 is another schematic flowchart of a method for transmitting downlink data according to still another embodiment of the present disclosure;

FIG. 11 is still another schematic flowchart of a method for transmitting downlink data according to still another embodiment of the present disclosure;

FIG. 12 is a schematic block diagram of a mobility management network element according to an embodiment of the present disclosure;

FIG. 13 is another schematic block diagram of a mobility management network element according to an embodiment of the present disclosure;

FIG. 14 is still another schematic block diagram of a mobility management network element according to an embodiment of the present disclosure;

FIG. 15 is still another schematic block diagram of a mobility management network element according to an embodiment of the present disclosure;

FIG. 16 is still another schematic block diagram of a mobility management network element according to an embodiment of the present disclosure;

FIG. 17 is a schematic block diagram of an access network device according to an embodiment of the present disclosure;

FIG. 18 is a schematic block diagram of a second determining module according to an embodiment of the present disclosure;

FIG. 19 is a schematic block diagram of a serving gateway according to an embodiment of the present disclosure;

FIG. 20 is a schematic block diagram of a mobility management network element according to another embodiment of the present disclosure;

FIG. 21 is a schematic block diagram of an access network device according to another embodiment of the present disclosure; and

FIG. 22 is a schematic block diagram of a serving gateway according to another embodiment of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should be understood that, the technical solutions of the embodiments of the present disclosure may be applied to various communications systems, such as: a Global System of Mobile Communications (“GSM”) system, a Code Division Multiple Access (“CDMA”) system, a Wideband Code Division Multiple Access (“WCDMA”) system, a general packet radio service (“GPRS”), a Long Term Evolution (“LTE”) system, an LTE frequency division duplex (“FDD”) system, an LTE time division duplex (“TDD”), a Universal Mobile Telecommunications System (“UMTS”), a Worldwide Interoperability for Microwave Access (“WiMAX”) communications system or the like.

It should also be understood that in the embodiments of the present disclosure, a user equipment (“UE”) may be referred to as a terminal, a mobile station (“MS”), a mobile terminal, and the like. The user equipment may communicate with one or more core networks through a radio access network (“RAN”). For example, the user equipment may be a mobile phone (also referred to as a “cellular” phone) or a computer with a mobile terminal. For example, the user equipment may also be a portable, pocket-sized, handheld, computer built-in, or in-vehicle mobile apparatus, which exchanges voice and/or data with the radio access network.

In the embodiments of the present disclosure, a base station may be a base transceiver station (“BTS”) in GSM or CDMA, or may be a NodeB (“NB”) in WCDMA, or may be an evolved NodeB (“ENB” or “e-NodeB”) in LTE, which is not limited in the present disclosure. However, for ease of description, the following embodiments are described by using an ENB as an example.

In the embodiments of the present disclosure, a mobility management network element may be a mobility management entity (“MME”). In a UMTS system, the mobility management network element may further be a serving GPRS support node (“SGSN”). For ease of description, an MME is used as an example for description in the following embodiments, but the present disclosure is not limited thereto.

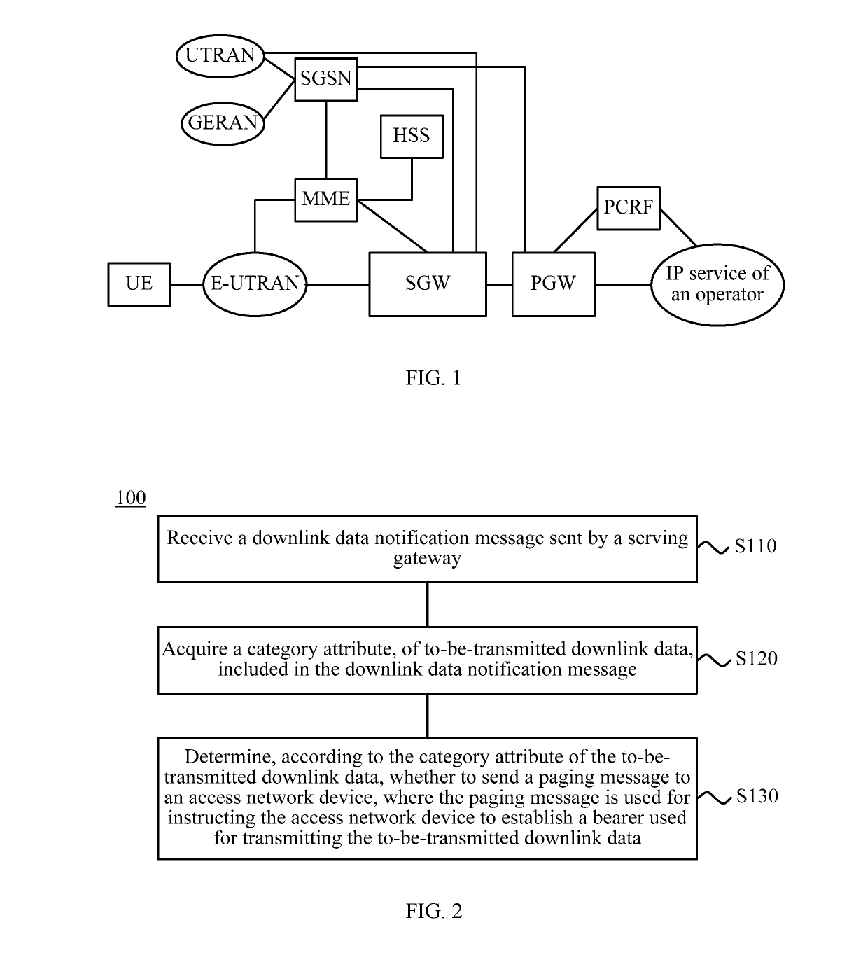

FIG. 1 is a schematic architecture diagram of an application scenario according to an embodiment of the present disclosure. As shown in FIG. 1, a 3GPP System Architecture Evolution (“SAE”) network may include: UE, an Evolved UMTS terrestrial radio access network (“E-UTRAN,” where Universal Mobile Telecommunications System (Universal Mobile Telecommunications System) is referred to as “UMTS”), a mobility management entity (“MME”), a serving gateway (“SGW”) entity, a packet data network gateway (“PGW”) entity, a policy and charging rules function (“PCRF”) entity, a home subscriber server (“HSS”), a serving general packet radio service support node (“SGSN”), a UMTS terrestrial radio access network (“UTRAN”), a GSM/EDGE radio access network (GSM/EDGE Radio Access Network, “GERAN,” where Enhanced Data Rate for GSM Evolution (Enhanced Data Rate for GSM Evolution) is referred to as “EDGE”), and the like.

When the UE accesses a core network through the SGSN, the UE may access the SGW through an S4 interface between the SGSN and the SGW, and then accesses the PGW through an S5 interface between the SGW and the PGW; or the UE may also directly access the PGW through a Gn/Gp interface between the SGSN and the PGW. A core network of a wireless evolved network mainly includes three logical function entities, that is, an MME, an SGW, and a PGW, where the MME is a mobility management network element and is responsible for signaling encryption in a non-access stratum (“NAS”), allocation of a temporary identity to the UE, selection of a core network element such as the SGW and the PGW, and provision of functions such as roaming, tracking, and security. The SGW is a mobility anchor for switching between local eNBs and provides functions related to lawful interception. The PGW is responsible for allocation of a subscriber address, execution of policy control and charging rules, and provides functions related to lawful interception. The HSS is configured to store subscription information of a subscriber. The PCRF is configured to provide policy and charging control rules.

Specifically, the PGW is a gateway connected to a PDN network (the network may be a packet network inside or outside a carrier) that provides a service and the PGW is responsible for forwarding and filtering of a data flow of a subscriber. The SGW is mainly responsible for relaying of a service flow of a subscriber between the UE and the PGW and is used as an anchor during switching between base stations. The PCRF is configured to decide, according to a limitation of an access network of a subscriber, a carrier policy, subscriber subscription data, information about a service being performed for the subscriber currently, and the like, a corresponding policy, and provide a transmission gateway with the policy for execution, thereby implementing policy charging control. The MME mainly completes functions such as mobility management and session management for UE connected to the E-UTRAN, encryption and integrity protection for NAS signaling, and selection of the PGW/SGW, and additionally, when the UE is in an idle state, the MME may save bearer context information. The SGSN mainly completes functions such as mobility management for UE connected to the GERAN/UTRAN and session management, and additionally, when the UE is in an Idle state, the SGSN may also save bearer context information.

It should be understood that application to an SAE system is used as an example for description in the embodiments of the present disclosure, but the present disclosure is not limited thereto. In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

FIG. 2 is a schematic flowchart of a method 100 for transmitting downlink data according to an embodiment of the present disclosure. The method 100 may be executed by a mobility management network element. For example, the method 100 may be executed by an MME or an SGSN. As shown in FIG. 2, the method 100 includes:

S110: Receive a downlink data notification message sent by a serving gateway.

S120: Acquire a category attribute, of to-be-transmitted downlink data, included in the downlink data notification message.

S130: Determine, according to the category attribute of the to-be-transmitted downlink data, whether to send a paging message to an access network device, where the paging message is used for instructing the access network device to establish a bearer used for transmitting the to-be-transmitted downlink data.

Specifically, for example, in a 3GPP SAE architecture, when user equipment is in an idle state, to save resources and save electrical power of the user equipment, a bearer used for transmitting data between the access network device and the serving gateway is deleted, and a bearer between the user equipment and the access network device is deleted. When downlink data needs to be transmitted to the user equipment, the mobility management network element receives the downlink data notification message sent by the serving gateway, so as to notify that the downlink data needs to be sent to the user equipment.

For example, in this embodiment of the present disclosure, the mobility management network element may first acquire the category attribute of the to-be-transmitted downlink data, and then determine, according to the category attribute of the to-be-transmitted downlink data, whether to send the paging message to the access network device. Specifically, the mobility management network element may receive a downlink data notification message sent by the serving gateway, where the downlink data notification message may be used for indicating that to-be-transmitted downlink data to be transmitted to the user equipment exists, and the downlink data notification message includes a category attribute of the to-be-transmitted downlink data. Therefore, the mobility management network element may acquire the category attribute, of the to-be-transmitted downlink data, included in the downlink data notification message. Therefore, the mobility management network element may determine, according to the category attribute of the to-be-transmitted downlink data, whether to send the paging message to the access network device, so as to instruct the access network device whether to establish a bearer used for transmitting the to-be-transmitted downlink data. That is, before the bearer between the access network device and the serving gateway and the bearer between the user equipment and the access network device are restored, whether to restore the bearers is controlled.

When determining, according to the category attribute of the to-be-transmitted downlink data, to send the paging message to the access network device, the mobility management network element may restore the bearer between the access network device and a gateway device and the bearer between the access network device and the user equipment, so as to transmit the downlink data. Otherwise, the mobility management network element may not send the paging message to the access network device, may not restore the bearer between the access network device and the gateway device, and may not restore the bearer between the access network device and the user equipment either. Therefore, the method may control transmission of downlink data, so as to determine whether to establish the bearer for transmitting the to-be-transmitted downlink data. Especially, during network congestion, congestion in data transmission can be mitigated.

Therefore, according to the method for transmitting downlink data in this embodiment of the present disclosure, a category attribute of to-be-transmitted downlink data is acquired, and it is determined, according to the category attribute of the to-be-transmitted downlink data, whether to send a paging message to an access network device, so as to determine whether to establish a bearer between the access network device and a serving gateway and a bearer between the access network device and user equipment. Therefore, in a process of transmitting downlink data, establishment of a bearer on an access network side can be controlled, so as to prevent blind establishment of a bearer on the access network side, so that signaling overheads can be reduced, and congestion in data transmission can be mitigated.

In S110 and S120, the mobility management network element may receive the downlink data notification message sent by the serving gateway, and acquire the category attribute, of the to-be-transmitted downlink data, included in the downlink data notification message, but the present disclosure is not limited thereto. For example, the mobility management network element may also acquire, according to a message that is sent by another gateway device or another network device and includes the category attribute, the category attribute of the to-be-transmitted downlink data.

In this embodiment of the present disclosure, optionally, the category attribute of the to-be-transmitted downlink data includes at least one piece of information of the following information: service type information of the to-be-transmitted downlink data, priority information of the to-be-transmitted downlink data, and quality of service information of the to-be-transmitted downlink data.

It should be understood that the category attribute of the to-be-transmitted downlink data may be used for identifying a different data flow. When the service type information of the to-be-transmitted downlink data is used for identification, an identified data flow may be, for example, a voice chat service, a video service, and a short message service. When the priority information of the to-be-transmitted downlink data is used for identification, an identified data flow may be, for example, a high priority service, an intermediate priority service, and a low priority service. When the quality of service information of the to-be-transmitted downlink data is used for identification, an identified data flow may be, for example, a high quality of service, and a low quality of service service.

It should also be understood that the category attribute of the to-be-transmitted downlink data may further include other information. That is, other information may also be used to categorize, distinguish or identify a data flow, and the present disclosure is not limited thereto.

In S130, the mobility management network element may determine, according to the category attribute of the to-be-transmitted downlink data, whether to send the paging message to the access network device, where the paging message is used for instructing the access network device to establish the bearer used for transmitting the to-be-transmitted downlink data. For example, the paging message is used for instructing the access network device to establish the bearer between the access network device and the serving gateway and the bearer between the access network device and the user equipment.

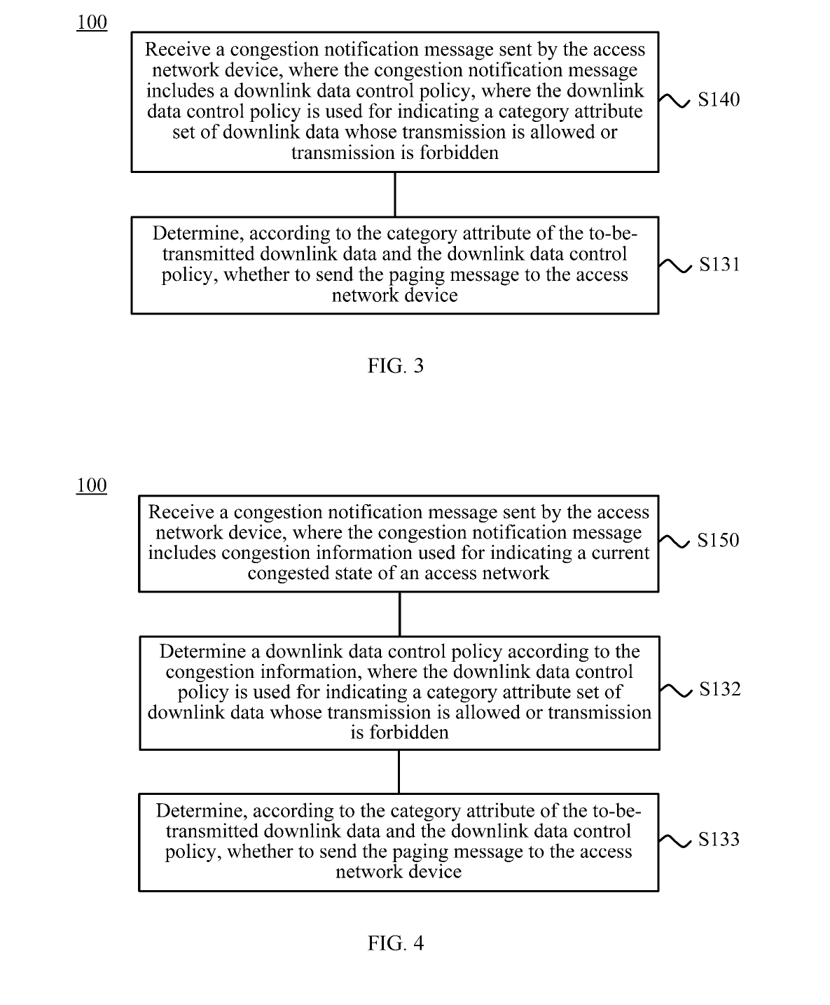

Specifically, in this embodiment of the present disclosure, optionally, as shown in FIG. 3, the method 100 further includes:

S140: Receive a congestion notification message sent by the access network device, where the congestion notification message includes a downlink data control policy, where the downlink data control policy is used for indicating a category attribute set of downlink data whose transmission is allowed or transmission is forbidden.

The determining, according to the category attribute of the to-be-transmitted downlink data, whether to send a paging message to an access network device includes:

S131: Determine, according to the category attribute of the to-be-transmitted downlink data and the downlink data control policy, whether to send the paging message to the access network device.

That is, in this embodiment of the present disclosure, the mobility management network element may determine, according to the downlink data control policy sent by the access network device, whether to send the paging message to the access network device.

Specifically, in this embodiment of the present disclosure, optionally, the determining, according to the category attribute of the to-be-transmitted downlink data and the downlink data control policy, whether to send the paging message to the access network device includes:

when it is determined that the category attribute of the to-be-transmitted downlink data belongs to the category attribute set, of the downlink data whose transmission is allowed, indicated by the downlink data control policy, or when it is determined that the category attribute of the to-be-transmitted downlink data does not belong to the category attribute set, of the downlink data whose transmission is forbidden, indicated by the downlink data control policy, determining to send the paging message to the access network device.

For example, the downlink data control policy included in the congestion notification message is used for indicating the category attribute set of the downlink data whose transmission is allowed. The category attribute set of the downlink data whose transmission is allowed includes, for example, a voice chat service, a short message service, a high priority service, and a high quality of service. For example, when the mobility management network element determines that the category attribute of the to-be-transmitted downlink data belongs to the short message service, the mobility management network element may determine to send the paging message to the access network device, so as to establish the bearer used for transmitting the to-be-transmitted downlink data, that is, establish the bearer between the access network device and the serving gateway and the bearer between the access network device and the user equipment. For another example, when the mobility management network element determines that the category attribute of the to-be-transmitted downlink data belongs to a low priority service, the mobility management network element may determine not to send the paging message to the access network device, or to preferably establish a bearer for to-be-transmitted downlink data whose category attribute is the high priority service, and the like.

It should be understood that, in another aspect, when determining that the category attribute of the to-be-transmitted downlink data does not belong to the category attribute set, of the downlink data whose transmission is allowed, indicated by the downlink data control policy, or when determining that the category attribute of the to-be-transmitted downlink data belongs to the category attribute set, of the downlink data whose transmission is forbidden, indicated by the downlink data control policy, the mobility management network element determines not to send the paging message to the access network device, that is, not to trigger establishment of the bearer used for transmitting the to-be-transmitted downlink data, that is, not to establish the bearer between the access network device and the serving gateway and the bearer between the access network device and the user equipment; or determines to suspend sending of the paging message to the access network device, or the like. This embodiment of the present disclosure is not limited thereto.

Therefore, according to the method for transmitting downlink data in this embodiment of the present disclosure, a category attribute of to-be-transmitted downlink data and a downlink data control policy sent by an access network device are acquired, and it is determined, according to the category attribute of the to-be-transmitted downlink data and the downlink data control policy, whether to send a paging message to the access network device, so as to determine whether to establish a bearer between the access network device and a serving gateway and a bearer between the access network device and user equipment. Therefore, in a process of transmitting downlink data, establishment of a bearer on an access network side can be controlled according to the downlink data control policy determined by the access network device, so as to prevent blind establishment of a bearer on the access network side, so that signaling overheads can be reduced, and congestion in data transmission can be mitigated.

Specifically, in this embodiment of the present disclosure, optionally, as shown in FIG. 4, the method 100 further includes:

S150: Receive a congestion notification message sent by the access network device, where the congestion notification message includes congestion information used for indicating a current congested state of an access network.

The determining, according to the category attribute of the to-be-transmitted downlink data, whether to send a paging message to an access network device includes:

S132: Determine a downlink data control policy according to the congestion information, where the downlink data control policy is used for indicating a category attribute set of downlink data whose transmission is allowed or transmission is forbidden.

S133: Determine, according to the category attribute of the to-be-transmitted downlink data and the downlink data control policy, whether to send the paging message to the access network device.

That is, in this embodiment of the present disclosure, the mobility management network element may determine, according to the congestion information used for indicating the current congested state of the access network, the downlink data control policy used for indicating the category attribute set of the downlink data whose transmission is allowed or transmission is forbidden, and therefore the mobility management network element may determine, according to the downlink data control policy determined by the mobility management network element, whether to send the paging message to the access network device.

Specifically, in this embodiment of the present disclosure, optionally, the determining, according to the category attribute of the to-be-transmitted downlink data and the downlink data control policy, whether to send the paging message to the access network device includes:

when it is determined that the category attribute of the to-be-transmitted downlink data belongs to the category attribute set, of the downlink data whose transmission is allowed, indicated by the downlink data control policy, or when it is determined that the category attribute of the to-be-transmitted downlink data does not belong to the category attribute set, of the downlink data whose transmission is forbidden, indicated by the downlink data control policy, determining to send the paging message to the access network device.

For example, the downlink data control policy included in the congestion notification message is used for indicating the category attribute set of the downlink data whose transmission is allowed. The category attribute set of the downlink data whose transmission is allowed includes, for example, a voice chat service, a short message service, a high priority service, and a high quality of service. For example, when the mobility management network element determines that the category attribute of the to-be-transmitted downlink data belongs to the short message service, the mobility management network element may determine to send the paging message to the access network device, so as to establish the bearer used for transmitting the to-be-transmitted downlink data, that is, establish the bearer between the access network device and the serving gateway and the bearer between the access network device and the user equipment. For another example, when the mobility management network element determines that the category attribute of the to-be-transmitted downlink data belongs to a low priority service, the mobility management network element may determine not to send the paging message to the access network device, or to preferably establish a bearer for to-be-transmitted downlink data whose category attribute is the high priority service, and the like.

It should be understood that, in another aspect, when determining that the category attribute of the to-be-transmitted downlink data does not belong to the category attribute set, of the downlink data whose transmission is allowed, indicated by the downlink data control policy, or when determining that the category attribute of the to-be-transmitted downlink data belongs to the category attribute set, of the downlink data whose transmission is forbidden, indicated by the downlink data control policy, the mobility management network element determines not to send the paging message to the access network device, that is, not to trigger establishment of the bearer used for transmitting the to-be-transmitted downlink data, that is, not to establish the bearer between the access network device and the serving gateway and the bearer between the access network device and the user equipment; or determines to suspend sending of the paging message to the access network device, or the like. This embodiment of the present disclosure is not limited thereto.

Therefore, according to the method for transmitting downlink data in this embodiment of the present disclosure, a category attribute of to-be-transmitted downlink data and congestion information for indicating a current congested state of an access network are acquired, a downlink data control policy is determined according to the congestion information, and it is determined, according to the category attribute of the to-be-transmitted downlink data and the downlink data control policy, whether to send a paging message to an access network device, so as to determine whether to establish a bearer between the access network device and a serving gateway and a bearer between the access network device and user equipment. Therefore, in a process of transmitting downlink data, establishment of a bearer on an access network side can be controlled according to a downlink data control policy determined by a mobility management network element, so as to prevent blind establishment of a bearer on the access network side, so that signaling overheads can be reduced, and congestion in data transmission can be mitigated.

It should be understood that, in this embodiment of the present disclosure, FIG. 3 and FIG. 4 are merely used as examples for description, but the present disclosure is not limited thereto. For example, the mobility management network element may further determine, according to a downlink data control policy determined by another network device, whether to send the paging message to the access network device, so as to control establishment of a bearer on an access network side. For another example, the mobility management network element may further determine a downlink data control policy according to other information, so as to control establishment of a bearer on an access network side and mitigate congestion in data transmission on a network.

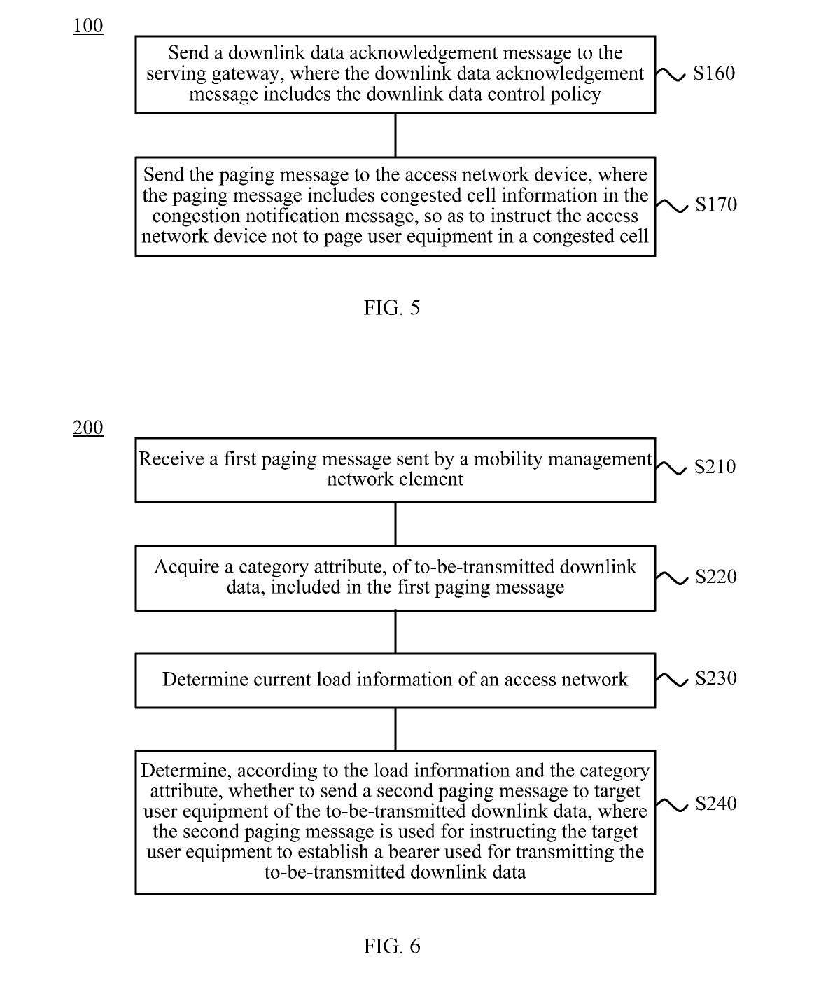

In this embodiment of the present disclosure, optionally, as shown in FIG. 5, the method 100 further includes:

S160: Send a downlink data acknowledgement message to the serving gateway, where the downlink data acknowledgement message includes the downlink data control policy.

Specifically, the mobility management network element may send the downlink data acknowledgement message to the SGW, where the downlink data acknowledgement message may include the downlink data control policy, and may further include other information, where the downlink data control policy is used for indicating the category attribute set of the downlink data whose transmission is allowed or transmission is forbidden. Therefore, when receiving to-be-transmitted downlink data again, the serving gateway may determine, according to the downlink data control policy, whether to send a downlink data notification message for the to-be-transmitted downlink data that is received again. Specifically, after receiving the downlink data acknowledgement message, the SGW may control, according to the downlink data control policy, the to-be-transmitted downlink data that is received again. For example, for to-be-transmitted downlink data whose category attribute belongs to the category attribute set of the downlink data whose transmission is forbidden, or for to-be-transmitted downlink data whose category attribute does not belong to the category attribute set of the downlink data whose transmission is allowed, the SGW no longer sends a downlink data notification message to an MME, and therefore does not establish the bearer between the access network device and the serving gateway and the bearer between the access network device and the user equipment.

Therefore, according to the method for transmitting downlink data in this embodiment of the present disclosure, a downlink data control policy is sent to a serving gateway, so that the serving gateway can control establishment of a bearer on an access network side in a process of transmitting downlink data, which can prevent blind establishment of a bearer on the access network side, so that signaling overheads can be reduced, and congestion in data transmission can be mitigated.

In this embodiment of the present disclosure, optionally, as shown in FIG. 5, the congestion notification message further includes congested cell information used for indicating a congested cell. After the determining to send the paging message to the access network device, the method 100 further includes:

S170: Send the paging message to the access network device, where the paging message includes the congested cell information in the congestion notification message, so as to instruct the access network device not to page user equipment in the congested cell.

Specifically, when the mobility management network element determines, according to the category attribute of the to-be-transmitted downlink data, to send the paging message to the access network device, so as to establish the bearer used for transmitting the to-be-transmitted downlink data, the mobility management network element may further add the congested cell information to the paging message sent to the access network device, so as to instruct the access network device not to page the user equipment in the congested cell, so that network congestion can be further mitigated.

Therefore, according to the method for transmitting downlink data in this embodiment of the present disclosure, information about a congested cell in which paging is forbidden and that is determined by a mobility management network element is sent to an access network device, so that the access network device can prevent paging of user equipment in a congested cell in a process of transmitting downlink data. Therefore, it is prevented that paging the user equipment in the congested cell increases network congestion, so that signaling overheads can be further reduced, and congestion in data transmission on a network can be further mitigated.

In this embodiment of the present disclosure, optionally, the determining, according to the category attribute of the to-be-transmitted downlink data, whether to send a paging message to an access network device includes:

when it is determined to send the paging message to the access network device, for at least two pieces of the to-be-transmitted downlink data, determining, according to at least one piece of information of the category attribute, a subscription attribute of the user equipment, and a quality of service class identifier QCI attribute, an order of sending the paging message to the access network device.

For example, when determining, according to the category attribute, of the to-be-transmitted downlink data, in the received downlink data notification message, to send the paging message to the access network device, the mobility management network element may initiate the paging message based on a priority order of the to-be-transmitted downlink data. For example, the paging message is triggered first for to-be-transmitted downlink data having a highest priority. Alternatively, in the process of decision making, a subscription attribute of the UE, a QCI attribute of a data packet, and the like are further considered to determine the order of sending the paging message. For example, for to-be-transmitted downlink data that is of a gold subscriber and has a QCI of 5, the paging message is triggered preferentially.

It should be understood that, in this embodiment of the present disclosure, when the mobility management network element determines to send the paging message, the paging message sent to the access network device may include the category attribute of the to-be-transmitted downlink data, so that the access network device controls data transmission according to the category attribute of the to-be-transmitted downlink data, but the present disclosure is not limited thereto.

It should be understood that, in this embodiment of the present disclosure, that user equipment is in an idle state is merely used as an example for description, but the present disclosure is not limited thereto, and this embodiment of the present disclosure may be further applied to a case in which user equipment is in a non-idle state. For example, for user equipment that is in a non-idle state and can establish various types of bearers, this embodiment of the present disclosure may be further applied to a process of restoring or establishing each type of bearer of the user equipment that is not established, so as to transmit downlink data. It should also be understood that, in this embodiment of the present disclosure, that a network is in a congested state is merely used as an example for description, but the present disclosure is also not limited thereto. It should also be understood that, in this embodiment of the present disclosure, an SAE architecture is merely used as an example for description, but the present disclosure is not limited thereto, and this embodiment of the present disclosure may be further applied to various other communication network architectures, where an access network may include a system such as a UTRAN and an E-UTRAN. An access network device may include a device such as an eNB. A mobility management network element may include a device such as an MME and an SGSN. A gateway device may include a device such as an SGW, a PGW, and a GGSN.

It should also be understood that sequence numbers of the foregoing processes do not mean execution sequences in various embodiments of the present disclosure. The execution sequences of the processes should be determined according to functions and internal logic of the processes, and should not be construed as any limitation on the implementation processes of the embodiments of the present disclosure.

Therefore, according to the method for transmitting downlink data in this embodiment of the present disclosure, a category attribute of to-be-transmitted downlink data is acquired, and it is determined, according to the category attribute of the to-be-transmitted downlink data, whether to send a paging message to an access network device, so as to determine whether to establish a bearer between the access network device and a serving gateway and a bearer between the access network device and user equipment. Therefore, in a process of transmitting downlink data, the access network device, a mobility management network element or the serving gateway can control, according to a downlink data control policy determined by the access network device or according to a downlink data control policy determined by the mobility management network element, establishment of a bearer on an access network side, so as to prevent blind establishment of a bearer on the access network side, and prevent that paging user equipment in a congested cell increases network congestion, so that signaling overheads can be significantly reduced, and congestion in data transmission can be significantly mitigated. The method for transmitting downlink data in this embodiment of the present disclosure is described above in detail with reference to FIG. 1 to FIG. 5 and from the perspective of a mobility management network element, and a method for transmitting downlink data according to an embodiment of the present disclosure is described below with reference to FIG. 6 to FIG. 8 and from the perspective of an access network device and a serving gateway.

FIG. 6 is a schematic flowchart of a method 200 for transmitting downlink data according to an embodiment of the present disclosure. The method 200 may be executed by an access network device. For example, the method 200 may be executed by an eNB. As shown in FIG. 6, the method 200 includes:

S210: Receive a first paging message sent by a mobility management network element.

S220: Acquire a category attribute, of to-be-transmitted downlink data, included in the first paging message.

S230: Determine current load information of an access network.

S240: Determine, according to the load information and the category attribute, whether to send a second paging message to target user equipment of the to-be-transmitted downlink data, where the second paging message is used for instructing the target user equipment to establish a bearer used for transmitting the to-be-transmitted downlink data.

Therefore, according to the method for transmitting downlink data in this embodiment of the present disclosure, current load information of an access network and a category attribute of to-be-transmitted downlink data are determined, and it is determined, according to the load information and the category attribute, whether to send a paging message to target user equipment of the to-be-transmitted downlink data, so as to determine whether to establish a bearer between an access network device and a serving gateway and a bearer between the access network device and user equipment. Therefore, in a process of transmitting downlink data, establishment of a bearer on an access network side can be controlled, so as to prevent blind establishment of a bearer on the access network side, so that signaling overheads can be reduced, and congestion in data transmission can be mitigated.

Specifically, in S210 and S220, the category attribute of the to-be-transmitted downlink data may be included in the first paging message, and is sent by the mobility management network element to the access network device. That is, the access network device may receive the first paging message that is sent by the mobility management network element and includes the category attribute of the to-be-transmitted downlink data, so as to acquire the category attribute, of the to-be-transmitted downlink data, included in the first paging message. It should be understood that the first paging message may be used for requesting the access network device to establish a bearer used for transmitting the to-be-transmitted downlink data, and the first paging message includes the category attribute of the to-be-transmitted downlink data.

For example, an MME may send a first paging message to an eNB, where the first paging message is not only used for requesting the access network device to establish a bearer for transmitting to-be-transmitted downlink data, and may further include a category attribute of the to-be-transmitted downlink data. Therefore, the eNB may determine, according to the category attribute of the to-be-transmitted downlink data, whether to send a second paging message to the target user equipment, so as to establish a bearer used for transmitting the to-be-transmitted downlink data, so that transmission of the to-be-transmitted downlink data is controlled.

It should be understood that, in this embodiment of the present disclosure, the access network device may receive the category attribute sent by the mobility management network element by using another message. The access network device may also acquire, according to a message that is sent by another network device and includes the category attribute, the category attribute of the to-be-transmitted downlink data, and control establishment of a bearer on an access network side, but the present disclosure is not limited thereto.

In this embodiment of the present disclosure, optionally, the category attribute of the downlink data includes at least one piece of information of the following information: service type information of the downlink data, priority information of the downlink data, and quality of service information of the downlink data.

It should be understood that the category attribute of the to-be-transmitted downlink data may be used for identifying a different data flow. When the service type information of the to-be-transmitted downlink data is used for identification, an identified data flow may be, for example, a voice chat service, a video service, and a short message service. When the priority information of the to-be-transmitted downlink data is used for identification, an identified data flow may be, for example, a high priority service, an intermediate priority service, and a low priority service. When the quality of service information of the to-be-transmitted downlink data is used for identification, an identified data flow may be, for example, a high quality of service, and a low quality of service service.

It should also be understood that the category attribute of the to-be-transmitted downlink data may further include other information. That is, other information may also be used to categorize, distinguish or identify a data flow, and the present disclosure is not limited thereto.

In S230, the access network device may determine the current load information of the access network. For example, the access network device may determine the current load information of the access network according to information such as a data packet loss rate and a transmission delay, for example, determine that the access network is currently in a severe congested state, a middle congested state, a low congested state, or the like, but the present disclosure is not limited thereto.

In S240, the access network device may determine, according to the load information and the category attribute, whether to send the second paging message to the target user equipment of the to-be-transmitted downlink data, where the second paging message is used for instructing the target user equipment to establish the bearer used for transmitting the to-be-transmitted downlink data.

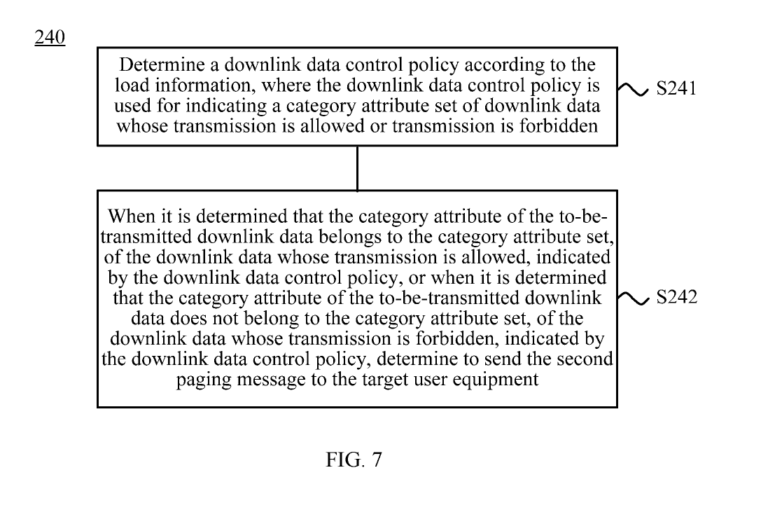

Optionally, as shown in FIG. 7, in this embodiment of the present disclosure, the determining, according to the load information and the category attribute, whether to send a second paging message to target user equipment of the to-be-transmitted downlink data includes:

S241: Determine a downlink data control policy according to the load information, where the downlink data control policy is used for indicating a category attribute set of downlink data whose transmission is allowed or transmission is forbidden.

S242: When it is determined that the category attribute of the to-be-transmitted downlink data belongs to the category attribute set, of the downlink data whose transmission is allowed, indicated by the downlink data control policy, or when it is determined that the category attribute of the to-be-transmitted downlink data does not belong to the category attribute set, of the downlink data whose transmission is forbidden, indicated by the downlink data control policy, determine to send the second paging message to the target user equipment.

It should be understood that, in another aspect, when determining that the category attribute of the to-be-transmitted downlink data does not belong to the category attribute set of the downlink data whose transmission is allowed, or when determining that the category attribute of the to-be-transmitted downlink data belongs to the category attribute set of the downlink data whose transmission is forbidden, the access network device may not send the second paging message to the target user equipment, or may also suspend sending of the second paging message to the target user equipment, but this embodiment of the present disclosure is not limited thereto.

It should be understood that, in this embodiment of the present disclosure, that the access network device determines the downlink data control policy according to the load information is merely used as an example for description, but the present disclosure is not limited thereto. For example, the access network device may further determine a downlink data control policy according to other information. The access network device may further receive a downlink data control policy determined by another network device, for example, may receive a downlink data control policy determined by the mobility management network element. Therefore, the access network device can control establishment of a bearer on an access network side, so as to prevent blind establishment of a bearer on the access network side, so that signaling overheads can be significantly reduced, and congestion in data transmission can be significantly mitigated.

It should be understood that, in this embodiment of the present disclosure, that user equipment is in an idle state is merely used as an example for description, but the present disclosure is not limited thereto, and this embodiment of the present disclosure may be further applied to a case in which user equipment is in a non-idle state. For example, for user equipment that is in a non-idle state and can establish various types of bearers, this embodiment of the present disclosure may be further applied to a process of restoring or establishing each type of bearer of the user equipment that is not established, so as to transmit downlink data. It should also be understood that, in this embodiment of the present disclosure, that a network is in a congested state is merely used as an example for description, but the present disclosure is also not limited thereto. It should also be understood that, in this embodiment of the present disclosure, an SAE architecture is merely used as an example for description, but the present disclosure is not limited thereto, and this embodiment of the present disclosure may be further applied to various other communication network architectures, where an access network may include a system such as a UTRAN and an E-UTRAN. An access network device may include a device such as an eNB. A mobility management network element may include a device such as an MME and an SGSN. A gateway device may include a device such as an SGW, a PGW, and a GGSN.

It should also be understood that sequence numbers of the foregoing processes do not mean execution sequences in various embodiments of the present disclosure. The execution sequences of the processes should be determined according to functions and internal logic of the processes, and should not be construed as any limitation on the implementation processes of the embodiments of the present disclosure.

Therefore, according to the method for transmitting downlink data in this embodiment of the present disclosure, current load information of an access network and a category attribute of to-be-transmitted downlink data are determined, a downlink data control policy is determined according to the load information, and therefore it can be determined whether to send a paging message to target user equipment of the to-be-transmitted downlink data, so as to determine whether to establish a bearer between an access network device and a serving gateway and a bearer between the access network device and user equipment. Therefore, in a process of transmitting downlink data, the access network device can control, according to a downlink data control policy determined by the access network device or according to a downlink data control policy determined by a mobility management network element, establishment of a bearer on an access network side, so as to prevent blind establishment of a bearer on the access network side, so that signaling overheads can be significantly reduced, and congestion in data transmission can be significantly mitigated.

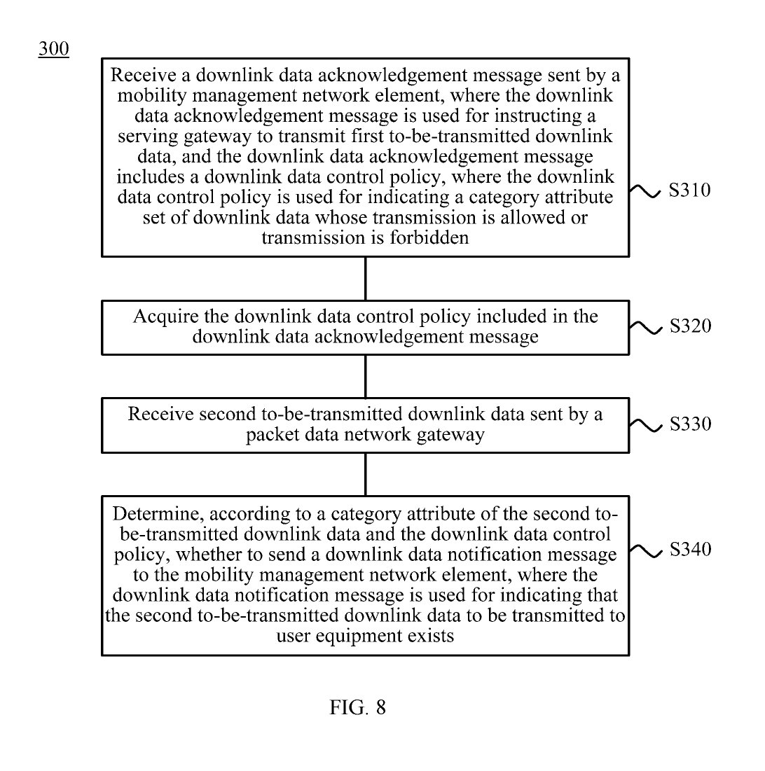

FIG. 8 is a schematic flowchart of a method 300 for transmitting downlink data according to an embodiment of the present disclosure. The method 300 may be executed by a serving gateway. For example, the method 300 may be executed by the SGW. As shown in FIG. 8, the method 300 includes:

S310: Receive a downlink data acknowledgement message sent by a mobility management network element, where the downlink data acknowledgement message is used for instructing the serving gateway to transmit first to-be-transmitted downlink data, and the downlink data acknowledgement message includes a downlink data control policy, where the downlink data control policy is used for indicating a category attribute set of downlink data whose transmission is allowed or transmission is forbidden.

S320: Acquire the downlink data control policy included in the downlink data acknowledgement message.

S330: Receive second to-be-transmitted downlink data sent by a packet data network gateway.

S340: Determine, according to a category attribute of the second to-be-transmitted downlink data and the downlink data control policy, whether to send a downlink data notification message to the mobility management network element, where the downlink data notification message is used for indicating that the second to-be-transmitted downlink data to be transmitted to user equipment exists.

Therefore, according to the method for transmitting downlink data in this embodiment of the present disclosure, a category attribute of to-be-transmitted downlink data and a downlink data control policy are acquired, and it is determined, according to the category attribute and the downlink data control policy, whether to send a downlink data notification message to a mobility management network element, so as to determine whether to establish a bearer between an access network device and a serving gateway and a bearer between the access network device and user equipment. Therefore, in a process of transmitting downlink data, establishment of a bearer on an access network side can be controlled, so as to prevent blind establishment of a bearer on the access network side, so that signaling overheads can be reduced, and congestion in data transmission can be mitigated.

Specifically, in S310 and S320, the downlink data control policy is included in the downlink data acknowledgement message sent by the mobility management network element, and the serving gateway may acquire the downlink data control policy according to the downlink data acknowledgement message.

It should be understood that, in this embodiment of the present disclosure, the serving gateway may receive the downlink data control policy sent by the mobility management network element by using another message. The serving gateway may also acquire, according to a message that is sent by another network device and includes the downlink data control policy, the downlink data control policy, and control establishment of a bearer on an access network side, but the present disclosure is not limited thereto.

In S330, the serving gateway receives the second to-be-transmitted downlink data sent by the packet data network gateway. It should be understood that, the serving gateway may determine, according to the second to-be-transmitted downlink data, the category attribute of the second to-be-transmitted downlink data. It should also be understood that, the serving gateway may also receive the category attribute of the second to-be-transmitted downlink data sent by the packet data network gateway, and this embodiment of the present disclosure is not limited thereto.

In this embodiment of the present disclosure, optionally, the category attribute of the downlink data includes at least one piece of information of the following information: service type information of the downlink data, priority information of the downlink data, and quality of service information of the downlink data.

It should be understood that the category attribute of the to-be-transmitted downlink data may be used for identifying a different data flow. When the service type information of the to-be-transmitted downlink data is used for identification, an identified data flow may be, for example, a voice chat service, a video service, and a short message service. When the priority information of the to-be-transmitted downlink data is used for identification, an identified data flow may be, for example, a high priority service, an intermediate priority service, and a low priority service. When the quality of service information of the to-be-transmitted downlink data is used for identification, an identified data flow may be, for example, a high quality of service, and a low quality of service service.

It should also be understood that the category attribute of the to-be-transmitted downlink data may further include other information. That is, other information may also be used to categorize, distinguish or identify a data flow, and the present disclosure is not limited thereto.

In S340, the serving gateway may determine, according to the category attribute of the second to-be-transmitted downlink data and the downlink data control policy, whether to send the downlink data notification message to the mobility management network element, where the downlink data notification message is used for indicating that the second to-be-transmitted downlink data to be transmitted to the user equipment exists.

Specifically, in this embodiment of the present disclosure, optionally, the determining, according to a category attribute of the second to-be-transmitted downlink data and the downlink data control policy, whether to send a downlink data notification message to the mobility management network element includes:

when it is determined that the category attribute of the second to-be-transmitted downlink data belongs to the category attribute set, of the downlink data whose transmission is allowed, indicated by the downlink data control policy, or when it is determined that the category attribute of the second to-be-transmitted downlink data does not belong to the category attribute set, of the downlink data whose transmission is forbidden, indicated by the downlink data control policy, determining to send the downlink data notification message to the mobility management network element.

It should be understood that, in another aspect, when determining that the category attribute of the second to-be-transmitted downlink data does not belong to the category attribute set of the downlink data whose transmission is allowed, or when determining that the category attribute of the second to-be-transmitted downlink data belongs to the category attribute set of the downlink data whose transmission is forbidden, the serving gateway may not send the downlink data notification message to the mobility management network element, or may also suspend sending of the downlink data notification message to the mobility management network element, but this embodiment of the present disclosure is not limited thereto.

It should be understood that, in this embodiment of the present disclosure, that user equipment is in an idle state is merely used as an example for description, but the present disclosure is not limited thereto, and this embodiment of the present disclosure may be further applied to a case in which user equipment is in a non-idle state. For example, for user equipment that is in a non-idle state and can establish various types of bearers, this embodiment of the present disclosure may be further applied to a process of restoring or establishing each type of bearer of the user equipment that is not established, so as to transmit downlink data. It should also be understood that, in this embodiment of the present disclosure, that a network is in a congested state is merely used as an example for description, but the present disclosure is also not limited thereto. It should also be understood that, in this embodiment of the present disclosure, an SAE architecture is merely used as an example for description, but the present disclosure is not limited thereto, and this embodiment of the present disclosure may be further applied to various other communication network architectures, where an access network may include a system such as a UTRAN and an E-UTRAN. An access network device may include a device such as an eNB. A mobility management network element may include a device such as an MME and an SGSN. A gateway device may include a device such as an SGW, a PGW, and a GGSN.

It should also be understood that sequence numbers of the foregoing processes do not mean execution sequences in various embodiments of the present disclosure. The execution sequences of the processes should be determined according to functions and internal logic of the processes, and should not be construed as any limitation on the implementation processes of the embodiments of the present disclosure.

Therefore, according to the method for transmitting downlink data in this embodiment of the present disclosure, a downlink data control policy and a category attribute of second to-be-transmitted downlink data are acquired, and it can be determined, according to the downlink data control policy and the category attribute, whether to send a downlink data notification message to a mobility management network element, so as to determine whether to establish a bearer between an access network device and a serving gateway and a bearer between the access network device and user equipment. Therefore, in a process of transmitting downlink data, the serving gateway can control, according to a downlink data control policy determined by the mobility management network element, establishment of a bearer on an access network side, so as to prevent blind establishment of a bearer on the access network side, so that signaling overheads can be significantly reduced, and congestion in data transmission can be significantly mitigated.

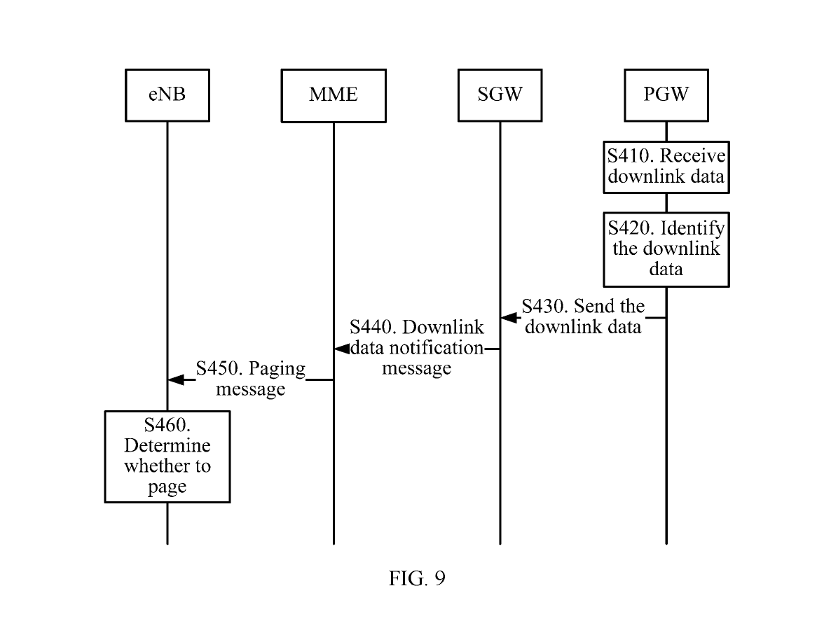

The methods for transmitting downlink data in the embodiments of the present disclosure are described above in detail with reference to FIG. 1 to FIG. 8 and separately from the perspectives of a mobility management network element, an access network device, and a serving gateway. A method for transmitting downlink data according to an embodiment of the present disclosure is described below with reference to FIG. 9 to FIG. 11 and from the perspective of interaction between devices.

FIG. 9 is a schematic flowchart of a method for transmitting downlink data according to still another embodiment of the present disclosure. In the method, an eNB determines whether to send a paging message to target user equipment of to-be-transmitted downlink data, where the paging message is used for instructing the target user equipment to establish a bearer used for transmitting the to-be-transmitted downlink data.

In S410, a PGW receives to-be-transmitted downlink data. For example, the PGW receives to-be-transmitted downlink data from a network.

In S420, the PGW uses a category attribute of the to-be-transmitted downlink data to identify the to-be-transmitted downlink data. For example, the category attribute of the to-be-transmitted downlink data includes at least one piece of information of the following information: service type information of the to-be-transmitted downlink data, priority information of the to-be-transmitted downlink data, and quality of service information of the to-be-transmitted downlink data.

In S430, the PGW sends, to an SGW, the to-be-transmitted downlink data that is identified with the category attribute of the to-be-transmitted downlink data.

In S440, the SGW sends a downlink data notification message to an MME, where the downlink data notification message includes the category attribute of the to-be-transmitted downlink data, for example, includes the service type information, the priority information, and the like.

In S450, the MME sends a paging message to an eNB, where the paging message includes the category attribute of the to-be-transmitted downlink data.

In S460, the eNB determines whether to send a paging message to target user equipment, so as to establish a bearer used for transmitting the to-be-transmitted downlink data.

For example, the eNB may determine, according to current load information of an access network and the category attribute, whether to send the paging message to the target user equipment. Specifically, for example, when the category attribute of the to-be-transmitted downlink data is the priority information, if the access network is in a low congested state, the eNB may reject to trigger paging for to-be-transmitted downlink data having a lowest priority. If the access network is in a middle congested state, the eNB may reject to trigger paging for to-be-transmitted downlink data having a low priority. If the access network is in a severe congested state, the eNB may reject to trigger paging for to-be-transmitted downlink data having an intermediate priority. For another example, when the category attribute of the to-be-transmitted downlink data is the service type information, in different congestion levels, some service types may also be selected as service types that are to be processed preferentially, but the present disclosure is not limited thereto.

It should be understood that sequence numbers of the foregoing processes do not mean execution sequences in various embodiments of the present disclosure. The execution sequences of the processes should be determined according to functions and internal logic of the processes, and should not be construed as any limitation on the implementation processes of the embodiments of the present disclosure.

Therefore, according to the method for transmitting downlink data in this embodiment of the present disclosure, current load information of an access network and a category attribute of to-be-transmitted downlink data are determined, and it is determined, according to the load information and the category attribute, whether to send a paging message to target user equipment of the to-be-transmitted downlink data, so as to determine whether to establish a bearer between an access network device and a serving gateway and a bearer between the access network device and user equipment. Therefore, in a process of transmitting downlink data, the access network device can control, according to a downlink data control policy determined by the access network device or according to a downlink data control policy determined by a mobility management network element, establishment of a bearer on an access network side, so as to prevent blind establishment of a bearer on the access network side, so that signaling overheads can be significantly reduced, and congestion in data transmission can be significantly mitigated.

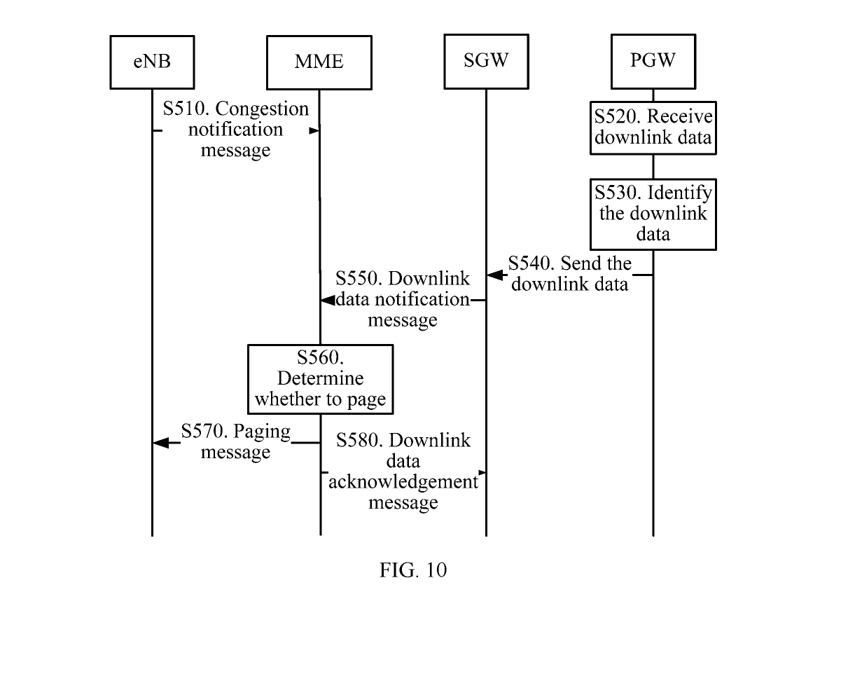

FIG. 10 is another schematic flowchart of a method for transmitting downlink data according to still another embodiment of the present disclosure. In the method, an MME determines, according to a downlink data control policy sent by an access network device, whether to send a paging message to the access network device, where the paging message is used for instructing the access network device to establish a bearer used for transmitting to-be-transmitted downlink data.

As shown in FIG. 10, in S510, an eNB sends a congestion notification message to an MME, where the congestion notification message includes a downlink data control policy, where the downlink data control policy is used for indicating a category attribute set of downlink data whose transmission is allowed or transmission is forbidden, for example, information such as a priority or a service type of the downlink data whose transmission is allowed or transmission is forbidden.

In S520, a PGW receives to-be-transmitted downlink data. For example, the PGW receives the to-be-transmitted downlink data from a network.

In S530, the PGW uses a category attribute of the to-be-transmitted downlink data to identify the to-be-transmitted downlink data. For example, the category attribute of the to-be-transmitted downlink data includes at least one piece of information of the following information: service type information of the to-be-transmitted downlink data, priority information of the to-be-transmitted downlink data, and quality of service information of the to-be-transmitted downlink data.

In S540, the PGW sends, to an SGW, the to-be-transmitted downlink data that is identified with the category attribute of the to-be-transmitted downlink data.

In S550, the SGW sends a downlink data notification message to an MME, where the downlink data notification message includes the category attribute of the to-be-transmitted downlink data, for example, includes the service type information, the priority information, and the like.

In S560, the MME determines, according to the category attribute of the to-be-transmitted downlink data and the downlink data control policy, whether to send a paging message to an access network device. In S570, the MME sends the paging message to the eNB, so as to establish a bearer used for transmitting the to-be-transmitted downlink data.

Optionally, when the congestion notification message further includes congested cell information used for indicating a congested cell, the paging message sent by the MME to the eNB further includes the congested cell information, so that the access network device does not page user equipment in the congested cell.

Optionally, when the MME determines to send the paging message to the access network device, for at least two pieces of to-be-transmitted downlink data, the MME determines, according to at least one piece of information of the category attribute, a subscription attribute of the user equipment, and a quality of service class identifier QCI attribute, an order of sending the paging message to the access network device.

For example, if the category attribute of the to-be-transmitted downlink data is the priority information, to-be-transmitted downlink data having a high priority is paged preferentially. If the category attribute of the to-be-transmitted downlink data is the service type information, paging of a specific service type may be preferentially triggered according to the downlink data control policy. For example, paging of a QQ service is preferentially triggered. If the category attribute of the to-be-transmitted downlink data is the quality of service information, paging may be triggered preferentially for to-be-transmitted downlink data having high quality of service.

Specifically, the MME may determine whether to send the paging message in multiple manners. For example, within a particular period of time, for example, within 5 seconds, when the MME determines, according to the category attribute, of the to-be-transmitted downlink data, in the received downlink data notification message, to send the paging message to the access network device, the MME may initiate the paging message based on a priority order of the downlink data. For example, the paging message is triggered first for to-be-transmitted downlink data having a highest priority. Alternatively, in the process of decision making, a subscription attribute of the UE, a QCI attribute of a data packet, and the like are further considered to determine the order of sending the paging message. For example, for downlink data that is of a gold subscriber and has a QCI of 5, the paging message is preferentially triggered.

In S580, the MME sends a downlink data acknowledgement message to the SGW, where the downlink data acknowledgement message includes the downlink data control policy, so that the SGW determines, according to the downlink data control policy, whether to send the downlink data notification message.

It should be understood that sequence numbers of the foregoing processes do not mean execution sequences in various embodiments of the present disclosure. The execution sequences of the processes should be determined according to functions and internal logic of the processes, and should not be construed as any limitation on the implementation processes of the embodiments of the present disclosure.

Therefore, according to the method for transmitting downlink data in this embodiment of the present disclosure, a category attribute of to-be-transmitted downlink data is acquired, and it is determined, according to the category attribute of the to-be-transmitted downlink data, whether to send a paging message to an access network device, so as to determine whether to establish a bearer between the access network device and a serving gateway and a bearer between the access network device and user equipment. Therefore, in a process of transmitting downlink data, the access network device, a mobility management network element or the serving gateway can control, according to a downlink data control policy determined by the access network device or according to a downlink data control policy determined by the mobility management network element, establishment of a bearer on an access network side, so as to prevent blind establishment of a bearer on the access network side, and prevent that paging user equipment in a congested cell increases network congestion, so that signaling overheads can be significantly reduced, and congestion in data transmission can be significantly mitigated.

FIG. 11 is still another schematic flowchart of a method for transmitting downlink data according to still another embodiment of the present disclosure. In the method, an MME determines a downlink data control policy according to congestion information sent by an access network device, and therefore determines whether to send a paging message to the access network device, where the paging message is used for instructing the access network device to establish a bearer used for transmitting to-be-transmitted downlink data.

As shown in FIG. 11, in S610, an eNB sends a congestion notification message to an MME, where the congestion notification message includes congestion information used for indicating a current congested state of an access network. For example, the congestion information is used for indicating that the access network is currently in a severe congested state, an intermediate congested state, and the like.

In S620, a PGW receives to-be-transmitted downlink data. For example, the PGW receives to-be-transmitted downlink data from a network.

In S630, the PGW uses a category attribute of the to-be-transmitted downlink data to identify the to-be-transmitted downlink data. For example, the category attribute of the to-be-transmitted downlink data includes at least one piece of information of the following information: service type information of the to-be-transmitted downlink data, priority information of the to-be-transmitted downlink data, and quality of service information of the to-be-transmitted downlink data.

In S640, the PGW sends, to an SGW, the to-be-transmitted downlink data that is identified with the category attribute of the to-be-transmitted downlink data.

In S650, the SGW sends a downlink data notification message to an MME, where the downlink data notification message includes the category attribute of the to-be-transmitted downlink data, for example, includes the service type information, the priority information, and the like.

In S660, the MME determines a downlink data control policy according to the congestion information, where the downlink data control policy is used for indicating a category attribute set of downlink data whose transmission is allowed or transmission is forbidden.

In S670, the MME may determine, according to the category attribute of the to-be-transmitted downlink data and the downlink data control policy, whether to send a paging message to an access network device.

In S680, the MME sends the paging message to the eNB, so as to establish a bearer used for transmitting the to-be-transmitted downlink data.

Optionally, when the congestion notification message further includes congested cell information used for indicating a congested cell, the paging message sent by the MME to the eNB further includes the congested cell information, so that the access network device does not page user equipment in the congested cell.

Optionally, the MME may send a downlink data acknowledgement message to the SGW, where the downlink data acknowledgement message includes the downlink data control policy, so that the SGW determines, according to the downlink data control policy, whether to send the downlink data notification message.

It should be understood that sequence numbers of the foregoing processes do not mean execution sequences in various embodiments of the present disclosure. The execution sequences of the processes should be determined according to functions and internal logic of the processes, and should not be construed as any limitation on the implementation processes of the embodiments of the present disclosure.

Therefore, according to the method for transmitting downlink data in this embodiment of the present disclosure, a category attribute of to-be-transmitted downlink data is acquired, and it is determined, according to the category attribute of the to-be-transmitted downlink data, whether to send a paging message to an access network device, so as to determine whether to establish a bearer between the access network device and a serving gateway and a bearer between the access network device and user equipment. Therefore, in a process of transmitting downlink data, the access network device, a mobility management network element or the serving gateway can control, according to a downlink data control policy determined by the access network device or according to a downlink data control policy determined by the mobility management network element, establishment of a bearer on an access network side, so as to prevent blind establishment of a bearer on the access network side, and prevent that paging user equipment in a congested cell increases network congestion, so that signaling overheads can be significantly reduced, and congestion in data transmission can be significantly mitigated.

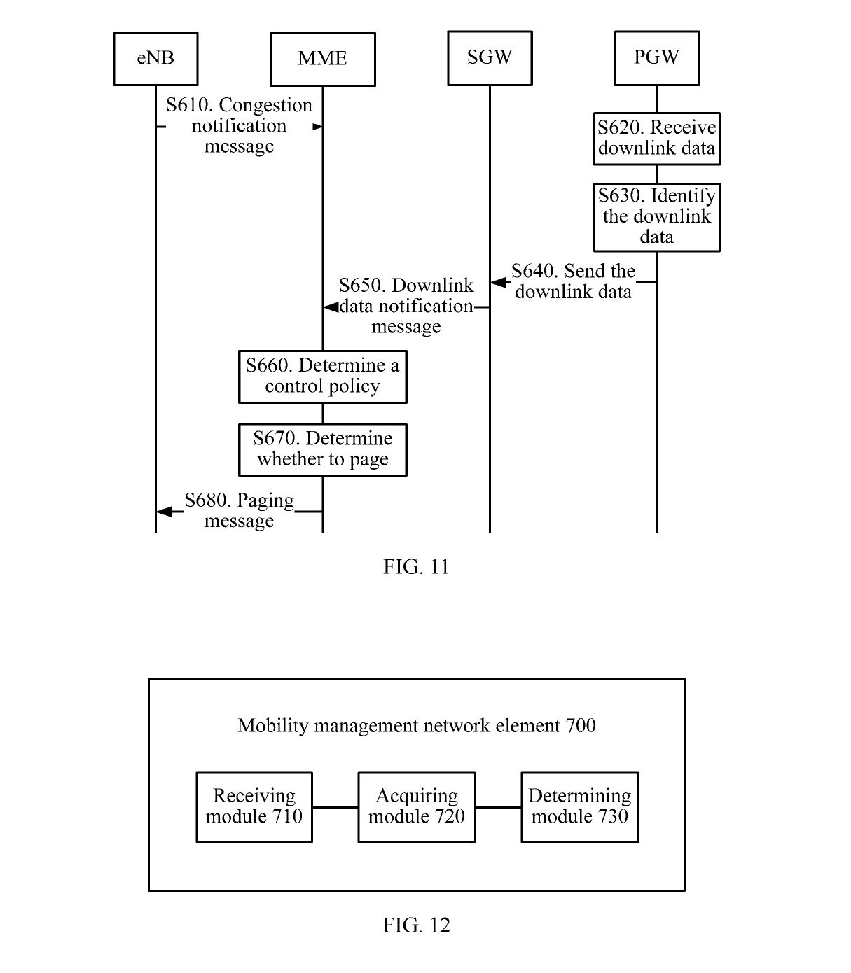

The methods for transmitting downlink data in the embodiments of the present disclosure are described above in detail with reference to FIG. 1 to FIG. 11. The mobility management network element, the access network device, and the serving gateway according to the embodiments of the present disclosure are described below in detail with reference to FIG. 12 to FIG. 22.

FIG. 12 is a schematic block diagram of a mobility management network element 700 according to an embodiment of the present disclosure. As shown in FIG. 12, the mobility management network element 700 includes:

a receiving module 710, configured to receive a downlink data notification message sent by a serving gateway;

an acquiring module 720, configured to acquire a category attribute, of to-be-transmitted downlink data, included in the downlink data notification message received by the receiving module 710; and

a determining module 730, configured to determine, according to the category attribute, of the to-be-transmitted downlink data, acquired by the acquiring module 720, whether to send a paging message to an access network device, where the paging message is used for instructing the access network device to establish a bearer used for transmitting the to-be-transmitted downlink data.

Therefore, according to the mobility management network element in this embodiment of the present disclosure, a category attribute of to-be-transmitted downlink data is acquired, and it is determined, according to the category attribute of the to-be-transmitted downlink data, whether to send a paging message to an access network device, so as to determine whether to establish a bearer between the access network device and a serving gateway and a bearer between the access network device and user equipment. Therefore, in a process of transmitting downlink data, establishment of a bearer on an access network side can be controlled, so as to prevent blind establishment of a bearer on the access network side, so that signaling overheads can be reduced, and congestion in data transmission can be mitigated.

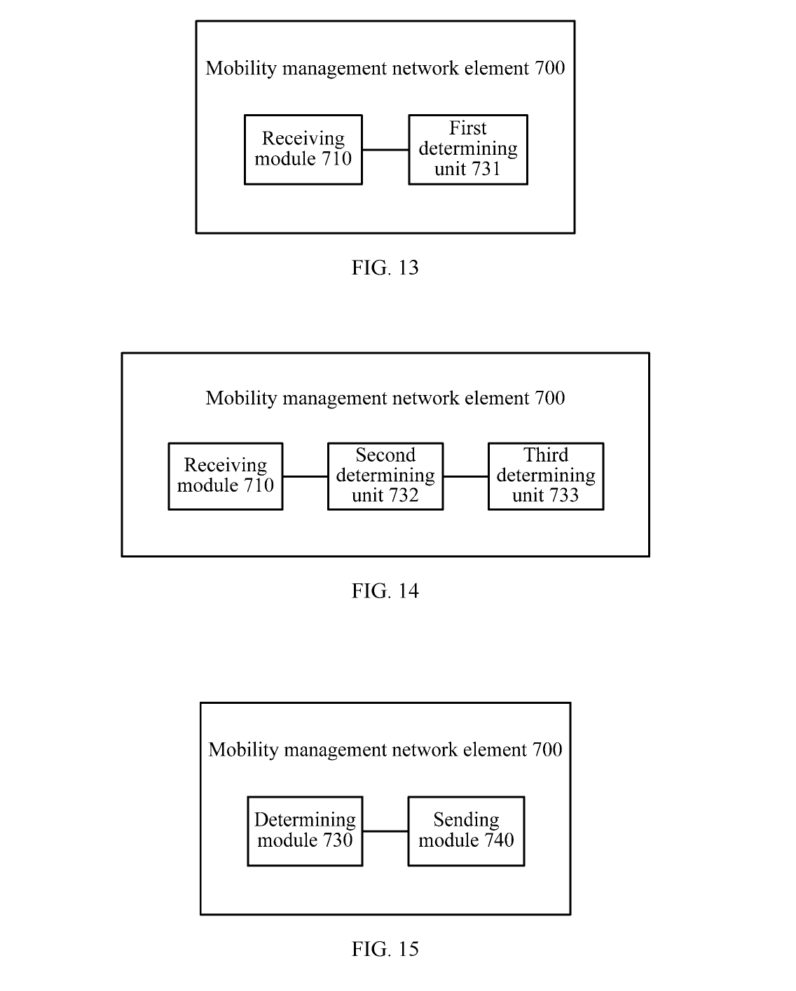

Optionally, in this embodiment of the present disclosure, as shown in FIG. 13, the receiving module 710 is further configured to receive a congestion notification message sent by the access network device, where the congestion notification message includes a downlink data control policy, where the downlink data control policy is used for indicating a category attribute set of downlink data whose transmission is allowed or transmission is forbidden;

The determining module 730 includes:

a first determining unit 731, configured to determine, according to the category attribute of the to-be-transmitted downlink data and the downlink data control policy received by the receiving module 710, whether to send the paging message to the access network device.

In this embodiment of the present disclosure, optionally, as shown in FIG. 14, the receiving module 710 is further configured to receive a congestion notification message sent by the access network device, where the congestion notification message includes congestion information used for indicating a current congested state of an access network.

The determining module 730 includes:

a second determining unit 732, configured to determine a downlink data control policy according to the congestion information received by the receiving module 710, where the downlink data control policy is used for indicating a category attribute set of downlink data whose transmission is allowed or transmission is forbidden; and

a third determining unit 733, configured to determine, according to the category attribute of the to-be-transmitted downlink data and the downlink data control policy determined by the second determining unit 732, whether to send the paging message to the access network device.

Optionally, in this embodiment of the present disclosure, the determining module 730 is specifically configured to:

when it is determined that the category attribute of the to-be-transmitted downlink data belongs to the category attribute set, of the downlink data whose transmission is allowed, indicated by the downlink data control policy, or when it is determined that the category attribute of the to-be-transmitted downlink data does not belong to the category attribute set, of the downlink data whose transmission is forbidden, indicated by the downlink data control policy, determine to send the paging message to the access network device.

Optionally, in this embodiment of the present disclosure, as shown in FIG. 15, the mobility management network element 700 further includes:

a sending module 740, configured to: after the determining module 730 determines to send the paging message to the access network device, send a downlink data acknowledgement message to the serving gateway, where the downlink data acknowledgement message includes the downlink data control policy.

Optionally, in this embodiment of the present disclosure, as shown in FIG. 15, the congestion notification message further includes congested cell information used for indicating a congested cell; and the mobility management network element 700 further includes:

a sending module 740, configured to: after the determining module 730 determines to send the paging message to the access network device, send the paging message to the access network device, where the paging message includes the congested cell information in the congestion notification message, so as to instruct the access network device not to page user equipment in the congested cell.

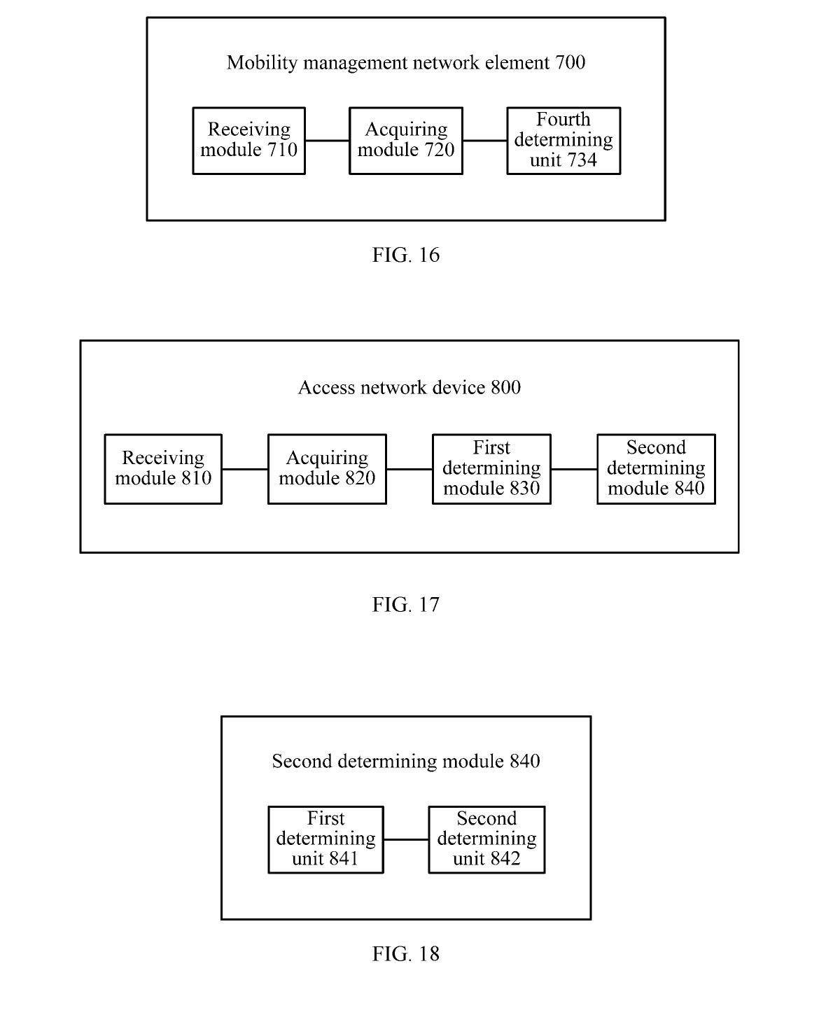

In this embodiment of the present disclosure, optionally, as shown in FIG. 16, the determining module 730 includes:

a fourth determining unit 734, configured to: when it is determined to send the paging message to the access network device, for at least two pieces of the to-be-transmitted downlink data, determine, according to at least one piece of information of the category attribute, a subscription attribute of the user equipment, and a quality of service class identifier QCI attribute, an order of sending the paging message to the access network device.

In this embodiment of the present disclosure, optionally, the category attribute, of the to-be-transmitted downlink data, acquired by the acquiring module 720 includes at least one piece of information of the following information: service type information of the to-be-transmitted downlink data, priority information of the to-be-transmitted downlink data, and quality of service information of the to-be-transmitted downlink data.

Optionally, the mobility management network element 700 in this embodiment of the present disclosure may be an MME or an SGSN.

It should be understood that, in this embodiment of the present disclosure, the acquiring module and the determining module may be included in a processing module, and the processing module is, for example, a processor, but the present disclosure is not limited thereto.

It should be understood that, the mobility management network element 700 in this embodiment of the present disclosure may correspond to an execution body of the methods for transmitting downlink data according to the embodiments of the present disclosure, and the foregoing and other operations and/or functions of the modules in the mobility management network element 700 are separately used to implement corresponding procedures of the methods in FIG. 1 to FIG. 5 and the methods in FIG. 9 to FIG. 11, and are no longer elaborated herein for brevity.

Therefore, according to the mobility management network element in this embodiment of the present disclosure, a category attribute of to-be-transmitted downlink data is acquired, and it is determined, according to the category attribute of the to-be-transmitted downlink data, whether to send a paging message to an access network device, so as to determine whether to establish a bearer between the access network device and a serving gateway and a bearer between the access network device and user equipment. Therefore, in a process of transmitting downlink data, the access network device, the mobility management network element or the serving gateway can control, according to a downlink data control policy determined by the access network device or according to a downlink data control policy determined by the mobility management network element, establishment of a bearer on an access network side, so as to prevent blind establishment of a bearer on the access network side, and prevent that paging user equipment in a congested cell increases network congestion, so that signaling overheads can be significantly reduced, and congestion in data transmission can be significantly mitigated.

FIG. 17 is a schematic block diagram of an access network device 800 according to an embodiment of the present disclosure. As shown in FIG. 17, the access network device 800 includes:

a receiving module 810, configured to receive a first paging message sent by a mobility management network element;

an acquiring module 820, configured to acquire a category attribute, of to-be-transmitted downlink data, included in the first paging message received by the receiving module 810;

a first determining module 830, configured to determine current load information of an access network; and

a second determining module 840, configured to determine, according to the load information determined by the first determining module 830 and the category attribute acquired by the acquiring module 820, whether to send a second paging message to target user equipment of the to-be-transmitted downlink data, where the second paging message is used for instructing the target user equipment to establish a bearer used for transmitting the to-be-transmitted downlink data.

Therefore, according to the access network device in this embodiment of the present disclosure, current load information of an access network and a category attribute of to-be-transmitted downlink data are determined, and it is determined, according to the load information and the category attribute, whether to send a paging message to target user equipment of the to-be-transmitted downlink data, so as to determine whether to establish a bearer between the access network device and a serving gateway and a bearer between the access network device and user equipment. Therefore, in a process of transmitting downlink data, establishment of a bearer on an access network side can be controlled, so as to prevent blind establishment of a bearer on the access network side, so that signaling overheads can be reduced, and congestion in data transmission can be mitigated.

Optionally, in this embodiment of the present disclosure, as shown in FIG. 18, the second determining module 840 includes:

a first determining unit 841, configured to determine a downlink data control policy according to the load information, where the downlink data control policy is used for indicating a category attribute set of downlink data whose transmission is allowed or transmission is forbidden; and

a second determining unit 842, configured to: when the category attribute of the to-be-transmitted downlink data belongs to the category attribute set, of the downlink data whose transmission is allowed, indicated by the downlink data control policy, or when the category attribute of the to-be-transmitted downlink data does not belong to the category attribute set, of the downlink data whose transmission is forbidden, indicated by the downlink data control policy, determine to send the second paging message to user equipment.

In this embodiment of the present disclosure, optionally, the category attribute, of the to-be-transmitted downlink data, acquired by the acquiring module 820 includes at least one piece of information of the following information: service type information of the to-be-transmitted downlink data, priority information of the to-be-transmitted downlink data, and quality of service information of the to-be-transmitted downlink data.

It should be understood that, in this embodiment of the present disclosure, the acquiring module and the determining module may be included in a processing module, and the processing module is, for example, a processor, but the present disclosure is not limited thereto.

It should be understood that, the access network device 800 in this embodiment of the present disclosure may correspond to an execution body of the methods for transmitting downlink data according to the embodiments of the present disclosure, and the foregoing and other operations and/or functions of the modules in the access network device 800 are separately used to implement corresponding procedures of the methods in FIG. 6 and FIG. 7 and FIG. 9 to FIG. 11, and are no longer elaborated herein for brevity.

Therefore, according to the access network device in this embodiment of the present disclosure, current load information of an access network and a category attribute of to-be-transmitted downlink data are determined, a downlink data control policy is determined according to the load information, and therefore it can be determined whether to send a paging message to target user equipment of the to-be-transmitted downlink data, so as to determine whether to establish a bearer between the access network device and a serving gateway and a bearer between the access network device and user equipment. Therefore, in a process of transmitting downlink data, the access network device can control, according to the downlink data control policy determined by the access network device or according to a downlink data control policy determined by a mobility management network element, establishment of a bearer on an access network side, so as to prevent blind establishment of a bearer on the access network side, so that signaling overheads can be significantly reduced, and congestion in data transmission can be significantly mitigated.

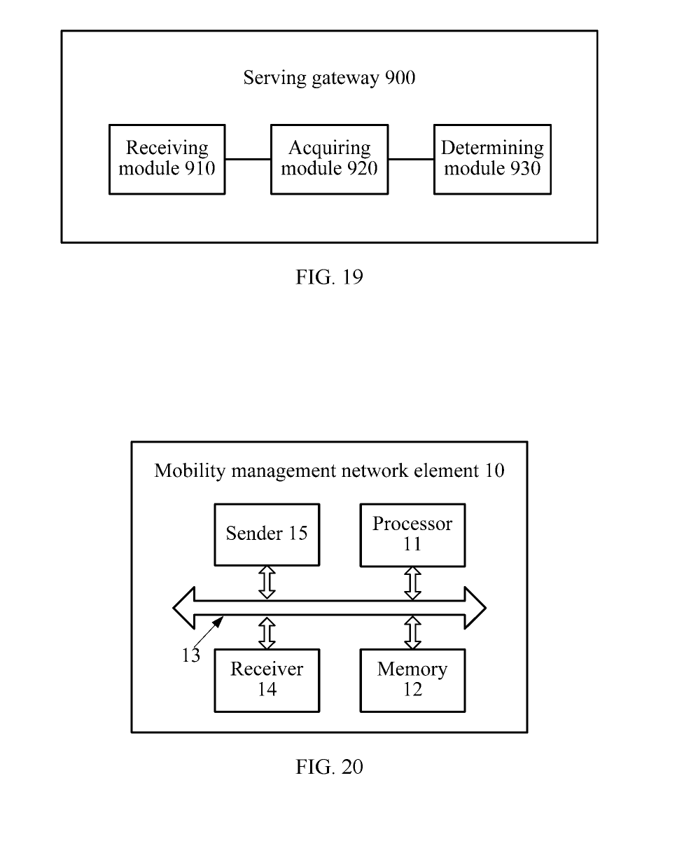

FIG. 19 is a schematic block diagram of a serving gateway 900 according to an embodiment of the present disclosure. As shown in FIG. 19, the serving gateway 900 includes:

a receiving module 910, configured to receive a downlink data acknowledgement message sent by a mobility management network element, where the downlink data acknowledgement message is used for instructing the serving gateway to transmit first to-be-transmitted downlink data, and the downlink data acknowledgement message includes a downlink data control policy, where the downlink data control policy is used for indicating a category attribute set of downlink data whose transmission is allowed or transmission is forbidden;

an acquiring module 920, configured to acquire the downlink data control policy included in the downlink data acknowledgement message received by the receiving module 910;

the receiving module 910, further configured to receive second to-be-transmitted downlink data sent by a packet data network gateway; and

a determining module 930, configured to determine, according to a category attribute of the second to-be-transmitted downlink data received by the receiving module 910 and the downlink data control policy acquired by the acquiring module 920, whether to send a downlink data notification message to the mobility management network element, where the downlink data notification message is used for indicating that the second to-be-transmitted downlink data to be transmitted to user equipment exists.

Therefore, according to the gateway device in this embodiment of the present disclosure, a category attribute of to-be-transmitted downlink data and a downlink data control policy are acquired, and it is determined, according to the category attribute and the downlink data control policy, whether to send a downlink data notification message to a mobility management network element, so as to determine whether to establish a bearer between an access network device and a serving gateway and a bearer between the access network device and user equipment. Therefore, in a process of transmitting downlink data, establishment of a bearer on an access network side can be controlled, so as to prevent blind establishment of a bearer on the access network side, so that signaling overheads can be reduced, and congestion in data transmission can be mitigated.

Optionally, in this embodiment of the present disclosure, the determining module 930 is specifically configured to:

when the category attribute of the second to-be-transmitted downlink data belongs to the category attribute set, of the downlink data whose transmission is allowed, indicated by the downlink data control policy, or when the category attribute of the second to-be-transmitted downlink data does not belong to the category attribute set, of the downlink data whose transmission is forbidden, indicated by the downlink data control policy, determine to send the downlink data notification message to the mobility management network element.

Optionally, in this embodiment of the present disclosure, the category attribute of the second to-be-transmitted downlink data received by the receiving module 910 includes at least one piece of information of the following information: service type information of the second to-be-transmitted downlink data, priority information of the second to-be-transmitted downlink data, and quality of service information of the second to-be-transmitted downlink data.

It should be understood that, in this embodiment of the present disclosure, the acquiring module and the determining module may be included in a processing module, and the processing module is, for example, a processor, but the present disclosure is not limited thereto.

It should be understood that, the serving gateway 900 in this embodiment of the present disclosure may correspond to an execution body of the methods for transmitting downlink data according to the embodiments of the present disclosure, and the foregoing and other operations and/or functions of the modules in the serving gateway 900 are separately used to implement corresponding procedures of the methods in FIG. 8 to FIG. 11, and are no longer elaborated herein for brevity.

Therefore, according to the serving gateway in this embodiment of the present disclosure, a downlink data control policy and a category attribute of second to-be-transmitted downlink data are acquired, and it can be determined, according to the downlink data control policy and the category attribute, whether to send a downlink data notification message to a mobility management network element, so as to determine whether to establish a bearer between an access network device and the serving gateway and a bearer between the access network device and user equipment. Therefore, in a process of transmitting downlink data, the serving gateway can control, according to a downlink data control policy determined by the mobility management network element, establishment of a bearer on an access network side, so as to prevent blind establishment of a bearer on the access network side, so that signaling overheads can be significantly reduced, and congestion in data transmission can be significantly mitigated.

As shown in FIG. 20, an embodiment of the present disclosure further provides a mobility management network element 10, where the mobility management network element 10 includes a processor 11, a memory 12, a bus system 13, and a receiver 14. The processor 11, the memory 12, and the receiver 14 are connected through the bus system 13. The memory 12 is configured to store an instruction. The processor 11 is configured to execute the instruction stored in the memory 12, and control the receiver 14 to receive information. The receiver 14 is configured to receive a downlink data notification message sent by a serving gateway. The processor 11 is configured to: acquire a category attribute, of to-be-transmitted downlink data, included in the downlink data notification message; and determine, according to the category attribute of the to-be-transmitted downlink data, whether to send a paging message to an access network device, where the paging message is used for instructing the access network device to establish a bearer used for transmitting the to-be-transmitted downlink data.

Therefore, according to the mobility management network element in this embodiment of the present disclosure, a category attribute of to-be-transmitted downlink data is acquired, and it is determined, according to the category attribute of the to-be-transmitted downlink data, whether to send a paging message to an access network device, so as to determine whether to establish a bearer between the access network device and a serving gateway and a bearer between the access network device and user equipment. Therefore, in a process of transmitting downlink data, establishment of a bearer on an access network side can be controlled, so as to prevent blind establishment of a bearer on the access network side, so that signaling overheads can be reduced, and congestion in data transmission can be mitigated.

It should be understood that, in this embodiment of the present disclosure, the processor 11 may be a central processing unit (“CPU”), and the processor 11 may further be another general purpose processor, a digital signal processor (“DSP”), an application-specific integrated circuit (“ASIC”), a field-programmable gate array (“FPGA”) or another programmable logical device, discrete gate or transistor logical device, discrete hardware component, and the like. The general purpose processor may be a microprocessor or the processor may also be any conventional processor or the like.

The memory 12 may include a read-only memory and a random access memory, and provides the processor 11 with an instruction and data. A part of the memory 12 may further include a nonvolatile random access memory. For example, the memory 820 may further store information about a device type.

In addition to a data bus, the bus system 13 may further include a power bus, a control bus, and a status signal bus, and the like. However, for clear description, various types of buses in the figure are marked as the bus system 13.

In an implementation process, the steps in the foregoing methods may be implemented by using an integrated logic circuit of hardware in the processor 11 or an instruction in a software form. Steps of the methods disclosed with reference to the embodiments of the present disclosure may be directly executed and accomplished by means of a hardware processor, or may be executed and completed by using a combination of hardware and software modules in the processor. The software module may be located in a mature storage medium in the field, such as a random access memory, a flash memory, a read-only memory, a programmable read-only memory, an electrically-erasable programmable memory, or a register. The storage medium is located in the memory 12, and the processor 11 reads information in the memory 820 and accomplishes the steps in the foregoing methods in combination with hardware of the processor 11. To prevent repetition, no detailed description is provided herein.

Optionally, as an embodiment, the receiver 14 is further configured to receive a congestion notification message sent by the access network device, where the congestion notification message includes a downlink data control policy, where the downlink data control policy is used for indicating a category attribute set of downlink data whose transmission is allowed or transmission is forbidden; and that the processor 11 determines, according to the category attribute of the to-be-transmitted downlink data, whether to send a paging message to an access network device includes: determining, according to the category attribute of the to-be-transmitted downlink data and the downlink data control policy, whether to send the paging message to the access network device.

Optionally, as an embodiment, the receiver 14 is further configured to receive a congestion notification message sent by the access network device, where the congestion notification message includes congestion information used for indicating a current congested state of an access network; and that the processor 11 determines, according to the category attribute of the to-be-transmitted downlink data, whether to send a paging message to an access network device includes: determining a downlink data control policy according to the congestion information, where the downlink data control policy is used for indicating a category attribute set of downlink data whose transmission is allowed or transmission is forbidden; and determining, according to the category attribute of the to-be-transmitted downlink data and the downlink data control policy, whether to send the paging message to the access network device.

Optionally, as an embodiment, that the processor 11 determines, according to the category attribute of the to-be-transmitted downlink data and the downlink data control policy, whether to send the paging message to the access network device includes:

when it is determined that the category attribute of the to-be-transmitted downlink data belongs to the category attribute set, of the downlink data whose transmission is allowed, indicated by the downlink data control policy, or when it is determined that the category attribute of the to-be-transmitted downlink data does not belong to the category attribute set, of the downlink data whose transmission is forbidden, indicated by the downlink data control policy, determining to send the paging message to the access network device.

Optionally, as an embodiment, the mobility management network element 10 further includes a sender 15, where the sender 15 is configured to: after the processor 11 determines to send the paging message to the access network device, send a downlink data acknowledgement message to the serving gateway, where the downlink data acknowledgement message includes the downlink data control policy.

Optionally, as an embodiment, the congestion notification message further includes congested cell information used for indicating a congested cell; and the mobility management network element 10 further includes a sender 15, where the sender 15 is configured to: after the processor 11 determines to send the paging message to the access network device, send the paging message to the access network device, where the paging message includes the congested cell information in the congestion notification message, so as to instruct the access network device not to page user equipment in the congested cell.

Optionally, as an embodiment, that the processor 11 determines, according to the category attribute of the to-be-transmitted downlink data, whether to send a paging message to an access network device includes:

when it is determined to send the paging message to the access network device, for at least two pieces of the to-be-transmitted downlink data, determining, according to at least one piece of information of the category attribute, a subscription attribute of the user equipment, and a quality of service class identifier QCI attribute, an order of sending the paging message to the access network device.

Optionally, as an embodiment, the category attribute of the to-be-transmitted downlink data includes at least one piece of information of the following information: service type information of the to-be-transmitted downlink data, priority information of the to-be-transmitted downlink data, and quality of service information of the to-be-transmitted downlink data.

It should be understood that, the mobility management network element 10 in this embodiment of the present disclosure may correspond to an execution body of the methods for transmitting downlink data according to the embodiments of the present disclosure, and may correspond to the mobility management network element 700 in the embodiment of the present disclosure. The foregoing and other operations and/or functions of the modules in the mobility management network element 10 are separately used to implement corresponding procedures of the methods in FIG. 1 to FIG. 5 and the methods in FIG. 9 to FIG. 11, and are no longer elaborated herein for brevity.

Therefore, according to the mobility management network element in this embodiment of the present disclosure, a category attribute of to-be-transmitted downlink data is acquired, and it is determined, according to the category attribute of the to-be-transmitted downlink data, whether to send a paging message to an access network device, so as to determine whether to establish a bearer between the access network device and a serving gateway and a bearer between the access network device and user equipment. Therefore, in a process of transmitting downlink data, the access network device, the mobility management network element or the serving gateway can control, according to a downlink data control policy determined by the access network device or according to a downlink data control policy determined by the mobility management network element, establishment of a bearer on an access network side, so as to prevent blind establishment of a bearer on the access network side, and prevent that paging user equipment in a congested cell increases network congestion, so that signaling overheads can be significantly reduced, and congestion in data transmission can be significantly mitigated.

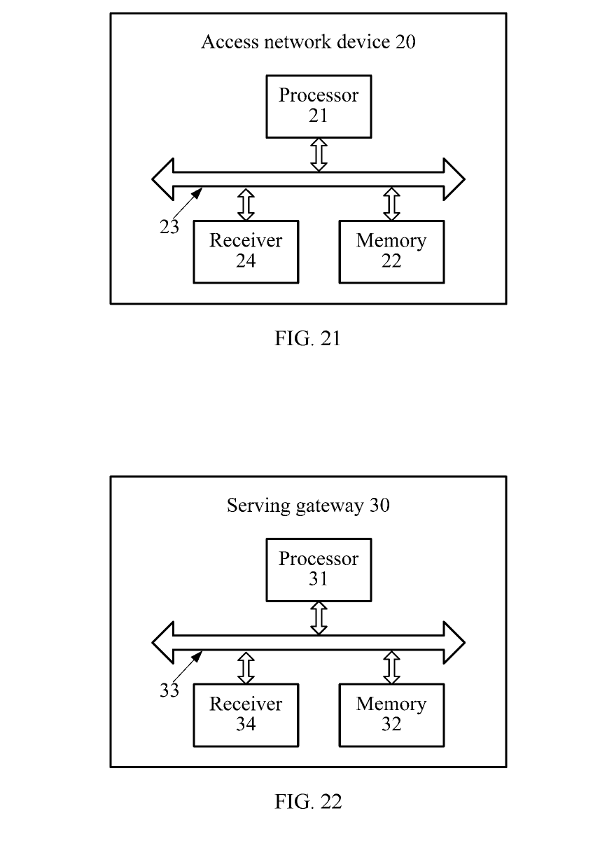

As shown in FIG. 21, an embodiment of the present disclosure further provides an access network device 20. The network device 20 includes a processor 21, a memory 22, a bus system 23, and a receiver 24. The processor 21, the memory 22, and the receiver 24 are connected through the bus system 23. The memory 22 is configured to store an instruction. The processor 21 is configured to execute the instruction stored in the memory 22, and control the receiver 24 to receive information. The receiver 24 is configured to receive a first paging message sent by a mobility management network element. The processor 21 is configured to: acquire a category attribute, of to-be-transmitted downlink data, included in the first paging message; determine current load information of an access network; and determine, according to the load information and the category attribute, whether to send a second paging message to target user equipment of the to-be-transmitted downlink data, where the second paging message is used for instructing the target user equipment to establish a bearer used for transmitting the to-be-transmitted downlink data.

Therefore, according to the access network device in this embodiment of the present disclosure, current load information of an access network and a category attribute of to-be-transmitted downlink data are determined, and it is determined, according to the load information and the category attribute, whether to send a paging message to target user equipment of the to-be-transmitted downlink data, so as to determine whether to establish a bearer between the access network device and a serving gateway and a bearer between the access network device and user equipment. Therefore, in a process of transmitting downlink data, establishment of a bearer on an access network side can be controlled, so as to prevent blind establishment of a bearer on the access network side, so that signaling overheads can be reduced, and congestion in data transmission can be mitigated.

It should be understood that, in this embodiment of the present disclosure, the processor 21 may be a central processing unit (“CPU”), and the processor 21 may further be another general purpose processor, a digital signal processor (“DSP”), an application-specific integrated circuit (“ASIC”), a field-programmable gate array (“FPGA”) or another programmable logical device, discrete gate or transistor logical device, discrete hardware component, and the like. The general purpose processor may be a microprocessor or the processor may also be any conventional processor or the like.

The memory 22 may include a read-only memory and a random access memory, and provides the processor 21 with an instruction and data. A part of the memory 22 may further include a nonvolatile random access memory. For example, the memory 22 may further store information about a device type.

In addition to a data bus, the bus system 23 may further include a power bus, a control bus, and a status signal bus, and the like. However, for clear description, various types of buses in the figure are marked as the bus system 23.

In an implementation process, the steps in the foregoing methods may be implemented by using an integrated logic circuit of hardware in the processor 21 or an instruction in a software form. Steps of the methods disclosed with reference to the embodiments of the present disclosure may be directly executed and accomplished by means of a hardware processor, or may be executed and completed by using a combination of hardware and software modules in the processor. The software module may be located in a mature storage medium in the field, such as a random access memory, a flash memory, a read-only memory, a programmable read-only memory, an electrically-erasable programmable memory, or a register. The storage medium is located in the memory 22, and the processor 21 reads information in the memory 22 and accomplishes the steps in the foregoing methods in combination with hardware of the processor 21. To prevent repetition, no detailed description is provided herein.

Optionally, as an embodiment, that the processor 21 determines, according to the load information and the category attribute, whether to send a second paging message to target user equipment of the to-be-transmitted downlink data includes:

determining a downlink data control policy according to the load information, where the downlink data control policy is used for indicating a category attribute set of downlink data whose transmission is allowed or transmission is forbidden; and

when it is determined that the category attribute of the to-be-transmitted downlink data belongs to the category attribute set, of the downlink data whose transmission is allowed, indicated by the downlink data control policy, or when it is determined that the category attribute of the to-be-transmitted downlink data does not belong to the category attribute set, of the downlink data whose transmission is forbidden, indicated by the downlink data control policy, determining to send the second paging message to the target user equipment.

Optionally, as an embodiment, the category attribute of the to-be-transmitted downlink data includes at least one piece of information of the following information: service type information of the to-be-transmitted downlink data, priority information of the to-be-transmitted downlink data, and quality of service information of the to-be-transmitted downlink data.

It should be understood that, the access network device 20 in this embodiment of the present disclosure may correspond to an execution body of the methods for transmitting downlink data according to the embodiments of the present disclosure, and may correspond to the access network device 800 in the embodiment of the present disclosure, and the foregoing and other operations and/or functions of the modules in the access network device 800 are separately used to implement corresponding procedures of the methods in FIG. 6 and FIG. 7 and FIG. 9 to FIG. 11, and are no longer elaborated herein for brevity.

Therefore, according to the access network device in this embodiment of the present disclosure, current load information of an access network and a category attribute of to-be-transmitted downlink data are determined, a downlink data control policy is determined according to the load information, and therefore it can be determined whether to send a paging message to target user equipment of the to-be-transmitted downlink data, so as to determine whether to establish a bearer between the access network device and a serving gateway and a bearer between the access network device and user equipment. Therefore, in a process of transmitting downlink data, the access network device can control, according to the downlink data control policy determined by the access network device or according to a downlink data control policy determined by a mobility management network element, establishment of a bearer on an access network side, so as to prevent blind establishment of a bearer on the access network side, so that signaling overheads can be significantly reduced, and congestion in data transmission can be significantly mitigated.

As shown in FIG. 22, an embodiment of the present disclosure further provides a serving gateway 30. The serving gateway 30 includes a processor 31, a memory 32, a bus system 33, and a receiver 34. The processor 31, the memory 32, and the receiver 34 are connected through the bus system 33. The memory 32 is configured to store an instruction. The processor 31 is configured to execute the instruction stored in the memory 32, and control the receiver 34 to receive information. The receiver 34 is configured to receive a downlink data acknowledgement message sent by a mobility management network element, where the downlink data acknowledgement message is used for instructing the serving gateway to transmit first to-be-transmitted downlink data, and the downlink data acknowledgement message includes a downlink data control policy, where the downlink data control policy is used for indicating a category attribute set of downlink data whose transmission is allowed or transmission is forbidden. The processor 31 is configured to: acquire the downlink data control policy included in the downlink data acknowledgement message; receive second to-be-transmitted downlink data sent by a packet data network gateway; and determine, according to a category attribute of the second to-be-transmitted downlink data and the downlink data control policy, whether to send a downlink data notification message to the mobility management network element, where the downlink data notification message is used for indicating that the second to-be-transmitted downlink data to be transmitted to user equipment exists.

Therefore, according to the gateway device in this embodiment of the present disclosure, a category attribute of to-be-transmitted downlink data and a downlink data control policy are acquired, and it is determined, according to the category attribute and the downlink data control policy, whether to send a downlink data notification message to a mobility management network element, so as to determine whether to establish a bearer between an access network device and a serving gateway and a bearer between the access network device and user equipment. Therefore, in a process of transmitting downlink data, establishment of a bearer on an access network side can be controlled, so as to prevent blind establishment of a bearer on the access network side, so that signaling overheads can be reduced, and congestion in data transmission can be mitigated.

It should be understood that, in this embodiment of the present disclosure, the processor 31 may be a central processing unit (“CPU”), and the processor 31 may further be another general purpose processor, a digital signal processor (“DSP”), an application-specific integrated circuit (“ASIC”), a field-programmable gate array (“FPGA”) or another programmable logical device, discrete gate or transistor logical device, discrete hardware component, and the like. The general purpose processor may be a microprocessor or the processor may also be any conventional processor or the like.

The memory 32 may include a read-only memory and a random access memory, and provides the processor 31 with an instruction and data. A part of the memory 32 may further include a nonvolatile random access memory. For example, the memory 32 may further store information about a device type.

In addition to a data bus, the bus system 33 may further include a power bus, a control bus, and a status signal bus, and the like. However, for clear description, various types of buses in the figure are marked as the bus system 33.

In an implementation process, the steps in the foregoing methods may be implemented by using an integrated logic circuit of hardware in the processor 31 or an instruction in a software form. Steps of the methods disclosed with reference to the embodiments of the present disclosure may be directly executed and accomplished by means of a hardware processor, or may be executed and completed by using a combination of hardware and software modules in the processor. The software module may be located in a mature storage medium in the field, such as a random access memory, a flash memory, a read-only memory, a programmable read-only memory, an electrically-erasable programmable memory, or a register. The storage medium is located in the memory 32, and the processor 31 reads information in the memory 32 and accomplishes the steps in the foregoing methods in combination with hardware of the processor 31. To prevent repetition, no detailed description is provided herein.

Optionally, as an embodiment, that the processor 31 determines, according to a category attribute of the second to-be-transmitted downlink data and the downlink data control policy, whether to send a downlink data notification message to the mobility management network element includes:

when it is determined that the category attribute of the second to-be-transmitted downlink data belongs to the category attribute set, of the downlink data whose transmission is allowed, indicated by the downlink data control policy, or when it is determined that the category attribute of the second to-be-transmitted downlink data does not belong to the category attribute set, of the downlink data whose transmission is forbidden, indicated by the downlink data control policy, determining to send the downlink data notification message to the mobility management network element.

Optionally, as an embodiment, the category attribute of the second to-be-transmitted downlink data includes at least one piece of information of the following information: service type information of the second to-be-transmitted downlink data, priority information of the second to-be-transmitted downlink data, and quality of service information of the second to-be-transmitted downlink data.

It should be understood that, the serving gateway 30 in this embodiment of the present disclosure may correspond to an execution body of the methods for transmitting downlink data according to the embodiments of the present disclosure, and may correspond to the serving gateway 900 in the embodiment of the present disclosure, and the foregoing and other operations and/or functions of the modules in the serving gateway 30 are separately used to implement corresponding procedures of the methods in FIG. 8 to FIG. 11, and are no longer elaborated herein for brevity.

Therefore, according to the serving gateway in this embodiment of the present disclosure, a downlink data control policy and a category attribute of second to-be-transmitted downlink data are acquired, and it can be determined, according to the downlink data control policy and the category attribute, whether to send a downlink data notification message to a mobility management network element, so as to determine whether to establish a bearer between an access network device and the serving gateway and a bearer between the access network device and user equipment. Therefore, in a process of transmitting downlink data, the serving gateway can control, according to a downlink data control policy determined by the mobility management network element, establishment of a bearer on an access network side, so as to prevent blind establishment of a bearer on the access network side, so that signaling overheads can be significantly reduced, and congestion in data transmission can be significantly mitigated.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or some of the steps of the methods described in the embodiments of the present disclosure. The foregoing storage medium includes: any medium that can store program code, such as a USB flash drive, a removable hard disk, a read-only memory (“ROM”), a random access memory (“RAM”), a magnetic disk, or an optical disc.

The foregoing descriptions are merely specific embodiments of the present disclosure, but are not intended to limit the protection scope of the present disclosure. Any modification or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A method for transmitting downlink data, comprising:
receiving a downlink data notification message sent by a serving gateway;
acquiring a category attribute of to-be-transmitted downlink data included in the downlink data notification message; and
determining, according to the category attribute of the to-be-transmitted downlink data, whether to send a paging message to an access network device.

2. The method according to claim 1, wherein the method further comprises:
receiving a congestion notification message sent by the access network device, wherein the congestion notification message comprises a downlink data control policy, wherein the downlink data control policy indicates a category attribute set of downlink data whose transmission is allowed or transmission is forbidden;
wherein the determining, according to the category attribute of the to-be-transmitted downlink data, whether to send the paging message to the access network device comprises:
determining, according to the category attribute of the to-be-transmitted downlink data and the downlink data control policy, whether to send the paging message to the access network device.

3. The method according to claim 1, wherein the method further comprises:
receiving a congestion notification message sent by the access network device, wherein the congestion notification message comprises congestion information indicates a current congested state of an access network;
wherein the determining, according to the category attribute of the to-be-transmitted downlink data, whether to send the paging message to the access network device comprises:
determining a downlink data control policy according to the congestion information, wherein the downlink data control policy indicates a category attribute set of downlink data whose transmission is allowed or transmission is forbidden; and
determining, according to the category attribute of the to-be-transmitted downlink data and the downlink data control policy, whether to send the paging message to the access network device.

4. The method according to claim 2, wherein the determining, according to the category attribute of the to-be-transmitted downlink data and the downlink data control policy, whether to send the paging message to the access network device comprises:
in response to determining that the category attribute of the to-be-transmitted downlink data belongs to the category attribute set[, of the downlink data whose transmission is allowed, indicated by the downlink data control policy, or in response to determining that the category attribute of the to-be-transmitted downlink data does not belong to the category attribute set, of the downlink data whose transmission is forbidden, indicated by the downlink data control policy, determining to send the paging message to the access network device.

5. The method according to claim 1, wherein the determining, according to the category attribute of the to-be-transmitted downlink data, whether to send the paging message to the access network device comprises:
in response to determining to send the paging message to the access network device, for at least two pieces of the to-be-transmitted downlink data, determining, according to at least one piece of information of the category attribute, a subscription attribute of the user equipment, and a quality of service class identifier (QCI) attribute, an order of sending the paging message to the access network device.

6. The method according to claim 1, wherein the category attribute of the to-be-transmitted downlink data comprises at least one piece of information of the following information: service type information of the to-be-transmitted downlink data, priority information of the to-be-transmitted downlink data, and quality of service information of the to-be-transmitted downlink data.

7. The method according to claim 1, wherein the paging message instructs the access network device to establish a bearer used for transmitting the to-be-transmitted downlink data.

8. A method for transmitting downlink data, comprising:
receiving a first paging message sent by a mobility management network element;
acquiring a category attribute of to-be-transmitted downlink data included in the first paging message;
determining current load information of an access network; and
determining, according to the load information and the category attribute, whether to send a second paging message to a target user equipment of the to-be-transmitted downlink data, wherein the second paging message instructs the target user equipment to establish a bearer used for transmitting the to-be-transmitted downlink data.

9. The method according to claim 8, wherein the determining, according to the load information and the category attribute, whether to send the second paging message to the target user equipment of the to-be-transmitted downlink data comprises:
determining a downlink data control policy according to the load information, wherein the downlink data control policy indicates a category attribute set of downlink data whose transmission is allowed or transmission is forbidden; and
in response to determining that the category attribute of the to-be-transmitted downlink data belongs to the category attribute set, of the downlink data whose transmission is allowed, indicated by the downlink data control policy, or in response to determining that the category attribute of the to-be-transmitted downlink data does not belong to the category attribute set, of the downlink data whose transmission is forbidden, indicated by the downlink data control policy, determining to send the second paging message to the target user equipment.

10. The method according to claim 8, wherein the category attribute of the to-be-transmitted downlink data comprises at least one piece of information of the following information: service type information of the to-be-transmitted downlink data, priority information of the to-be-transmitted downlink data, and quality of service information of the to-be-transmitted downlink data.

11. A method for transmitting downlink data, comprising:
receiving a downlink data acknowledgement message sent by a mobility management network element, wherein the downlink data acknowledgement message instructs a serving gateway to transmit first to-be-transmitted downlink data, and the downlink data acknowledgement message comprises a downlink data control policy, wherein the downlink data control policy indicates a category attribute set of downlink data whose transmission is allowed or transmission is forbidden;
acquiring the downlink data control policy comprised in the downlink data acknowledgement message;
receiving second to-be-transmitted downlink data sent by a packet data network gateway; and
determining, according to a category attribute of the second to-be-transmitted downlink data and the downlink data control policy, whether to send a downlink data notification message to the mobility management network element, wherein the downlink data notification message indicates that the second to-be-transmitted downlink data to be transmitted to a user equipment exists.

12. The method according to claim 11, wherein the determining, according to the category attribute of the second to-be-transmitted downlink data and the downlink data control policy, whether to send the downlink data notification message to the mobility management network element comprises:
in response to determining that the category attribute of the second to-be-transmitted downlink data belongs to the category attribute set, of the downlink data whose transmission is allowed, indicated by the downlink data control policy, or in response to determining that the category attribute of the second to-be-transmitted downlink data does not belong to the category attribute set, of the downlink data whose transmission is forbidden, indicated by the downlink data control policy, determining to send the downlink data notification message to the mobility management network element.

13. The method according to claim 11, wherein the category attribute of the second to-be-transmitted downlink data comprises at least one piece of information of the following information: service type information of the second to-be-transmitted downlink data, priority information of the second to-be-transmitted downlink data, and quality of service information of the second to-be-transmitted downlink data.

14. A mobility management network element, comprising:
a receiver configured to receive a downlink data notification message sent by a serving gateway; and
a processor configured to:
acquire a category attribute of to-be-transmitted downlink data included in the downlink data notification message; and
determine, according to the category attribute of the to-be-transmitted downlink data, whether to send a paging message to an access network device.

15. The mobility management network element according to claim 14, wherein:
the receiver is further configured to receive a congestion notification message sent by the access network device, wherein the congestion notification message comprises a downlink data control policy, wherein the downlink data control policy indicates a category attribute set of downlink data whose transmission is allowed or transmission is forbidden; and
the processor is further configured to determine, according to the category attribute of the to-be-transmitted downlink data and the downlink data control policy, whether to send the paging message to the access network device.

16. The mobility management network element according to claim 14, wherein:
the receiver is further configured to receive a congestion notification message sent by the access network device, wherein the congestion notification message comprises congestion information indicates a current congested state of an access network; and
the processor is further configured to:
determine a downlink data control policy according to the congestion information, wherein the downlink data control policy indicates a category attribute set of downlink data whose transmission is allowed or transmission is forbidden; and
determine, according to the category attribute of the to-be-transmitted downlink data and the downlink data control policy, whether to send the paging message to the access network device.

17. The mobility management network element according to claim 14, wherein the processor is further configured to:
in response to determining to send the paging message to the access network device, for at least two pieces of the to-be-transmitted downlink data, determine, according to at least one piece of information of the category attribute, a subscription attribute of the user equipment, and a quality of service class identifier (QCI) attribute, an order of sending the paging message to the access network device.

18. The mobility management network element according to claim 14, wherein the category attribute of the to-be-transmitted downlink data comprises at least one piece of information of the following information: service type information of the to-be-transmitted downlink data, priority information of the to-be-transmitted downlink data, and quality of service information of the to-be-transmitted downlink data.

19. The mobility management network element according to claim 14, wherein the paging message instructs the access network device to establish a bearer used for transmitting the to-be-transmitted downlink data.

20. An access network device, comprising:
a receiver configured to receive a first paging message sent by a mobility management network element; and
a processor configured to:
acquire a category attribute of to-be-transmitted downlink data included in the first paging message;
determine current load information of an access network; and
determine, according to the load information and the category attribute, whether to send a second paging message to a target user equipment of the to-be-transmitted downlink data, wherein the second paging message instructs the target user equipment to establish a bearer used for transmitting the to-be-transmitted downlink data.

21. The access network device according to claim 20, wherein the processor is further configured to:
determine a downlink data control policy according to the load information, wherein the downlink data control policy indicates a category attribute set of downlink data whose transmission is allowed or transmission is forbidden; and
in response to determining that category attribute of the to-be-transmitted downlink data belongs to the category attribute set, of the downlink data whose transmission is allowed, indicated by the downlink data control policy, or in response to determining that category attribute of the to-be-transmitted downlink data does not belong to the category attribute set, of the downlink data whose transmission is forbidden, indicated by the downlink data control policy, determine to send the second paging message to the target user equipment.

22. A serving gateway, comprising:
a receiver configured to receive a downlink data acknowledgement message sent by a mobility management network element, wherein the downlink data acknowledgement message instructs the serving gateway to transmit first to-be-transmitted downlink data, and the downlink data acknowledgement message comprises a downlink data control policy, wherein the downlink data control policy indicates a category attribute set of downlink data whose transmission is allowed or transmission is forbidden; and
a processor configured to:
acquire the downlink data control policy comprised in the downlink data acknowledgement message;
receive second to-be-transmitted downlink data sent by a packet data network gateway; and
determine, according to a category attribute of the second to-be-transmitted downlink data and the downlink data control policy, whether to send a downlink data notification message to the mobility management network element, wherein the downlink data notification message indicates that the second to-be-transmitted downlink data to be transmitted to a user equipment exists.

23. The serving gateway according to claim 22, wherein the processor is further configured to:
in response to determining that the category attribute of the second to-be-transmitted downlink data belongs to the category attribute set, of the downlink data whose transmission is allowed, indicated by the downlink data control policy, or in response to determining that the category attribute of the second to-be-transmitted downlink data does not belong to the category attribute set, of the downlink data whose transmission is forbidden, indicated by the downlink data control policy, determine to send the downlink data notification message to the mobility management network element.
